(19) United States
(12) Patent Application Publication
(10) Pub. No.: US 2026/0267624 A1
(43) Pub. Date: Sep. 10, 2026

(54) A SOFTWARE DEVELOPMENT PLATFORM

(71) Applicant: EVERLAST TECHNOLOGY PTY LTD, Brookvale (AU)

(72) Inventors: Paul Qian, Brookvale (AU); Qin Dai, Banrangaroo (AU)

(21) Appl. No.: 18/705,679

(22) PCT Filed: Oct. 28, 2022
(86) PCT No.: PCT/AU2022/051298

§ 371 Date: Apr. 29, 2024

(30) Foreign Application Priority Data
Oct. 29, 2021 (AU) 2021903463

(51) Int. Cl. G06F 8/36; G06F 8/35

(52) U.S. Cl. CPC G06F 8/36; G06F 8/35

(57) ABSTRACT

There is provided a software development platform for creating a customised software product. The platform includes an input module for facilitating input of client data, wherein the client data includes: data in a first programming language wherein the first programming language is HTML; data in a second programming language wherein the second programming language is JavaScript; and data in a third programming language wherein the third programming language is Java. The platform further includes a framework module including: a first programming language module including framework data in HTML and for receiving the inputted client data in HTML; a second intermediate controller module including framework data in JS and for receiving the inputted client data in JS; and a third data controller module including framework data in Java and for receiving the inputted client data in Java. Further, the first, second and third modules are operatively associated with each other such that, based on the inputted client data, the customised software product is generated. The platform further includes an output module for outputting and displaying the generated customised software product for future access and use.

### TECHNICAL FIELD

The present disclosure relates to a software development platform and, more specifically, to systems and methods, including computer program products, for developing customised information technology (IT) software. The present disclosure has applications to software development and in particular to developing software platforms in relation to internal IT systems for commercial enterprises.

While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

IT systems are commonplace across almost all industries as they provide a convenient way of recording, maintaining and accessing information in relation all aspects of a business in an ordered and efficient manner. In particular, companies will wish to run all aspects of their business through their IT systems, for example, accounting systems, customer profile management systems, performance management systems, and websites, amongst many others.

As such, companies have two major options for their IT systems:
1) Utilising one or more off-the-shelf software systems that adequately suit a company's requirements; and
2) Having one or more fully customised software systems that are developed from scratch, almost always outsourced to an external software developer, to specifically fulfil a company's requirements.

For option 1), whilst this can provide a relatively low-cost option, there is generally minimal customisation for the specific company. As such, the company has to adapt to the software systems rather than the systems being adapted for the company.

As companies even within the same industry have differing requirements to other companies, there is often a desire to implement option 2) where bespoke IT systems are developed to meet a particular company's requirements or wants. For this option, whilst a product more closely meets the specific requirements of the specific company; developing, testing and implementing such software is a long and costly process.

As such, in order to provide companies with a bespoke IT system without having to code such a system from scratch, frameworks such as application frameworks like Spring Framework and Play! Framework have been created to provide software developers with a basis to create a bespoke IT system.

Play! Framework 1.x is built for a software developer to easily use Apache Struts Framework, Hibernate object-relational mapping (ORM) and Spring Framework (each being classic model-view-controller (MVC) structures). As such, Play! utilises a combination of the technologies and tools, and whilst it provides the developers some flexibility, the use of Play! could be improved at least in terms of usability, simplicity of implementation and robustness of outputted product. However, Play! does not include plugins such as Charts, image/video galleries etc., amongst others.

### SUMMARY

It is an object of the present invention to overcome or ameliorate at least one of the disadvantages of the prior art, or to provide a useful alternative.

In accordance with a first aspect of the present invention there is provided a software development platform for creating a customised software product in the form of a persistent storage application associated with a relational database, the platform including:
an input module for facilitating input of client data in at least a first programming language;
a framework module including:
   a first programming language module for receiving the inputted client data;
   a second controller module including data in a second programming language, the second module including a plurality of pre-programmed code blocks of a second type; and
   a third centralised data controller module including data in a third programming language, the third module including a plurality of pre-programmed code blocks of a third type, wherein the first, second and third modules are operatively associated with each other such that, based on the inputted client data, the framework module automatically utilises one or more of the pre-programmed code blocks of the second type and one or more of the pre-programmed code blocks of the third type to generate the customised software product; and
an output module for outputting the customised software product,
wherein the third centralised data controller module utilizes a plurality of data rendering objects to map a third programming language entity to the relational database and subsequently maps to the third programming language entity a third programming language data rendering object, and the second controller module calls from the third module the third programming language data rendering object to be rendered in a text-based data format for forming at least part of the outputted customised software product,
further wherein the third centralised data controller module is configured to read one or more annotation instructions to automatically carry out one or more “create, read, update, and delete” (CRUD) operations,
further wherein the platform provides within the third module at least the following distinct framework annotations to define an entity:
   an entity annotation including one or more of: a rendering entity attribute; an entity document attachment path prefix attribute; an entity file type attribute;
   an entity validation method attribute; an entity display name attribute; and an entity description attribute;
   a CRUD list behaviour annotation including one or more of: a list column order attribute; a list ascending or descending order attribute; and a list columns attribute; and
   a CRUD list column annotation including one or more of: a parameter name attribute; a column heading attribute; and a filter field attribute, and
wherein the third centralised data controller module is separate from a page dispatcher.

In an embodiment, the first programming language is HyperText Markup Language (HTML).

In an embodiment, the second programming language is JavaScript (JS).

In an embodiment, the third programming language is Java.

In an embodiment, the text-based data format is JavaScript Object Notation (JSON).

In an embodiment, the customised software model includes one or more view modules.

In an embodiment, the one or more view modules includes one or more CRUD input tags.

In an embodiment, the one or more CRUD input tags includes one or more of: a text tag; an email tag; a password tag; a number tag; a uniform resource locator (URL) tag; a contact tag; one or more date tags; a text area tag; a toggle button tag; an address tag; a dropdown menu tag (single or multi selection); a checkbox tag; a radios tag; and a hidden input tag.

In accordance with a second aspect of the present invention there is provided a method for creating a customised software product in the form of a persistent storage application associated with a relational database, using the software development platform of the first aspect, the method including the steps of:
setting up, via the input module, a server environment upon which the software development platform is deployed;
creating, via the input module, an empty product from the software development platform;
inputting client data in at least a first programming language into the input module, the client data including code for rendering one or more features to be included in the customised software product;
based on the inputted client data, automatically utilising one or more of the pre-programmed code blocks of the second type and one or more of the pre-programmed code blocks of the third type to generate the customised software product; and
outputting, via the output module, the customised software product.

In an embodiment, the first programming language is HyperText Markup Language (HTML).

In an embodiment, the second programming language is JavaScript (JS).

In an embodiment, the third programming language is Java.

In an embodiment, the text-based data format is JavaScript Object Notation (JSON).

In accordance with a third aspect of the present invention there is provided a software development platform for creating a customised software product including a displayed widget, the platform including:
an input module for facilitating input of client data;
a framework module including:
   a first programming language module for receiving at least part of the inputted client data in a first programming language;
   a second controller module including data in a second programming language, the second module including a plurality of pre-programmed code blocks of a second type; and
   a third centralised data controller module including data in a third programming language, the third module for receiving at least part of the inputted client data in a third programming language, wherein the first, second and third modules are operatively associated with each other such that, based on the inputted client data, the framework module automatically calls data in a third programming language to utilise one or more of the pre-programmed code blocks of the second type to generate the customised software product; and
an output module for outputting the customised software product including the displayed widget,
wherein the third centralised data controller module utilizes a plurality of data rendering objects to map a third programming language entity to a relational database and subsequently maps to the third programming language entity a third programming language data rendering object, and the second controller module calls from the third module the third programming language data rendering object to be rendered in a text-based data format for forming at least part of the outputted customised software product,
further wherein the third centralised data controller module is configured to read one or more annotation instructions to automatically carry out one or more “create, read, update, and delete” (CRUD) operations,
further wherein the platform provides within the third module at least the following distinct framework annotations to define an entity:
   an entity annotation including one or more of: a rendering entity attribute; an entity document attachment path prefix attribute; an entity file type attribute;
   an entity validation method attribute; an entity display name attribute; and an entity description attribute;
   a CRUD list behaviour annotation including one or more of: a list column order attribute; a list ascending or descending order attribute; and a list columns attribute; and
   a CRUD list column annotation including one or more of: a parameter name attribute; a column heading attribute; and a filter field attribute, and
wherein the third centralised data controller module is separate from a page dispatcher.

In an embodiment, the first programming language is HyperText Markup Language (HTML).

In an embodiment, the second programming language is JavaScript (JS).

In an embodiment, the third programming language is Java.

In an embodiment, the customised software model includes one or more view modules.

In an embodiment, the one or more view modules includes one or more widget templates.

In an embodiment, the one or more widget templates includes one or more of: a chart widget; a document widget; one or more multimedia widget; one or more image widgets; one or more video widgets; a map widget; a table widget; and a vector map widget. In an embodiment, the one or more multimedia widget includes one or more images widgets and/or one or more video widgets.

In accordance with a fourth aspect of the present invention there is provided a method for creating a customised software product including a displayed widget, using the software development platform of the third aspect, the method including the steps of:
setting up, via the input module, a server environment upon which the software development platform is deployed;
creating, via the input module, an empty product from the software development platform;
inputting client data in a first programming language into the input module, the client data including code for rendering one or more features to be included in the customised software product;
based on the inputted client data, automatically calling data in a third programming language to utilise one or more of the pre-programmed code blocks of the second type to generate the customised software product; and
outputting, via the output module, the customised software product.

In an embodiment, the first programming language is HyperText Markup Language (HTML).

In an embodiment, the second programming language is JavaScript (JS).

The method according to any one of the preceding claims 21 to 23 wherein the third programming language is Java.

Other aspects of the present disclosure are also provided.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may be in some appropriate cases. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

One or more embodiments of the present disclosure will now be described by way of specific example(s) with reference to the accompanying drawings, in which:

FIG. 1 is a block diagram of a software development platform according to an embodiment of the invention;

FIG. 2 is a block diagram of a REST “create, read, update, and delete” (CRUD) structure and process flow according to the prior art;

FIG. 3 is a block diagram of a CRUD structure and process flow according to the platform of FIG. 1;

FIG. 4 is a block diagram of a computing system with which various embodiments of the present disclosure can be implemented/configurable to perform various features of the present disclosure;

FIG. 5A is example of client data inputted into the software development platform of FIG. 1;

FIG. 5B is an example of a widget feature of a customised software product outputted by the software development platform of FIG. 1 based on the inputted client data of FIG. 5A;

FIG. 5C is a block diagram of a widget implementation process flow according to the platform of FIG. 1 for the widget feature of FIG. 5B;

FIG. 6A is example of client data inputted into the software development platform of FIG. 1;

FIG. 6B is an example of a widget feature of a customised software product outputted by the software development platform of FIG. 1 based on the inputted client data of FIG. 6A;

FIG. 6C is a block diagram of a widget implementation process flow according to the platform of FIG. 1 for the widget feature of FIG. 6B;

FIG. 7A is example of client data inputted into the software development platform of FIG. 1;

FIG. 7B is an example of a widget feature of a customised software product outputted by the software development platform of FIG. 1 based on the inputted client data of FIG. 7A;

FIG. 7C is a block diagram of a widget implementation process flow according to the platform of FIG. 1 for the widget feature of FIG. 7B;

FIG. 8A is example of client data inputted into the software development platform of FIG. 1;

FIG. 8B is an example of a widget feature of a customised software product outputted by the software development platform of FIG. 1 based on the inputted client data of FIG. 8A;

FIG. 8C is a block diagram of a widget implementation process flow according to the platform of FIG. 1 for the widget feature of FIG. 8B;

FIG. 8D is an example of another embodiment of the widget feature of FIG. 8B;

FIG. 9A is example of client data inputted into the software development platform of FIG. 1;

FIG. 9B is an example of a widget feature of a customised software product outputted by the software development platform of FIG. 1 based on the inputted client data of FIG. 9A;

FIG. 9C is a block diagram of a widget implementation process flow according to the platform of FIG. 1 for the widget feature of FIG. 9B;

FIG. 10A is example of client data inputted into the software development platform of FIG. 1;

FIG. 10B is an example of a widget feature of a customised software product outputted by the software development platform of FIG. 1 based on the inputted client data of FIG. 10A;

FIG. 11A is example of client data inputted into the software development platform of FIG. 1;

FIG. 11B is an example of a widget feature of a customised software product outputted by the software development platform of FIG. 1 based on the inputted client data of FIG. 11A;

FIG. 11C is a block diagram of a widget implementation process flow according to the platform of FIG. 1 for the widget feature of FIG. 11B;

FIG. 12A is example of client data inputted into the software development platform of FIG. 1;

FIG. 12B is an example of a feature of a customised software product outputted by the software development platform of FIG. 1 based on the inputted client data of FIG. 12A;

FIG. 13A is example of client data inputted into the software development platform of FIG. 1;

FIG. 13B is an example of a feature of a customised software product outputted by the software development platform of FIG. 1 based on the inputted client data of FIG. 13A;

FIG. 14A is example of client data inputted into the software development platform of FIG. 1;

FIG. 14B is an example of a feature of a customised software product outputted by the software development platform of FIG. 1 based on the inputted client data of FIG. 14A;

FIG. 15A is example of client data inputted into the software development platform of FIG. 1;

FIG. 15B is an example of a feature of a customised software product outputted by the software development platform of FIG. 1 based on the inputted client data of FIG. 15A;

FIG. 16A is example of client data inputted into the software development platform of FIG. 1;

FIG. 16B is an example of a feature of a customised software product outputted by the software development platform of FIG. 1 based on the inputted client data of FIG. 16A;

FIG. 17A is example of client data inputted into the software development platform of FIG. 1;

FIG. 17B is an example of a feature of a customised software product outputted by the software development platform of FIG. 1 based on the inputted client data of FIG. 17A;

FIG. 18A is example of client data inputted into the software development platform of FIG. 1;

FIG. 18B is an example of a feature of a customised software product outputted by the software development platform of FIG. 1 based on the inputted client data of FIG. 18A;

FIG. 19A is example of client data inputted into the software development platform of FIG. 1;

FIG. 19B is an example of a feature of a customised software product outputted by the software development platform of FIG. 1 based on the inputted client data of FIG. 19A;

FIG. 20A is example of client data inputted into the software development platform of FIG. 1;

FIG. 20B is an example of a feature of a customised software product outputted by the software development platform of FIG. 1 based on the inputted client data of FIG. 20A;

FIG. 21A is example of client data inputted into the software development platform of FIG. 1;

FIG. 21B is an example of a feature of a customised software product outputted by the software development platform of FIG. 1 based on the inputted client data of FIG. 21A;

FIG. 22A is example of client data inputted into the software development platform of FIG. 1;

FIGS. 22B and 22C are examples of features of a customised software product outputted by the software development platform of FIG. 1 based on the inputted client data of FIG. 22A;

FIG. 23A is example of client data inputted into the software development platform of FIG. 1;

FIG. 23B is an example of a feature of a customised software product outputted by the software development platform of FIG. 1 based on the inputted client data of FIG. 23A;

FIG. 24A is example of client data inputted into the software development platform of FIG. 1;

FIG. 24B is an example of a feature of a customised software product outputted by the software development platform of FIG. 1 based on the inputted client data of FIG. 24A;

FIG. 25A is example of client data inputted into the software development platform of FIG. 1;

FIG. 25B is an example of a feature of a customised software product outputted by the software development platform of FIG. 1 based on the inputted client data of FIG. 25A;

FIG. 26A is example of client data inputted into the software development platform of FIG. 1;

FIG. 26B is an example of a feature of a customised software product outputted by the software development platform of FIG. 1 based on the inputted client data of FIG. 26A;

FIG. 27A is example of client data inputted into the software development platform of FIG. 1;

FIG. 27B is an example of a feature of a customised software product outputted by the software development platform of FIG. 1 based on the inputted client data of FIG. 27A;

FIG. 28A is example of client data inputted into the software development platform of FIG. 1 for utilising a third party plugin;

FIG. 28B is an example of a third party plugin feature of a customised software product outputted by the software development platform of FIG. 1 based on the inputted client data of FIG. 28A;

FIG. 29 is an example of a third party plugin feature of a customised software product outputted by the software development platform of FIG. 1;

FIG. 30A is example of client data inputted into the software development platform of FIG. 1 for utilising a third party plugin;

FIG. 30B is an example of a third party plugin feature of a customised software product outputted by the software development platform of FIG. 1 based on the inputted client data of FIG. 30A;

FIG. 31A is example of client data inputted into the software development platform of FIG. 1 for utilising a third party plugin;

FIG. 31B is an example of a third party plugin feature of a customised software product outputted by the software development platform of FIG. 1 based on the inputted client data of FIG. 31A;

FIG. 32 is a block diagram of a process flow according to the platform of FIG. 1;

FIG. 33 is a block diagram of a framework structure and process flow according to the prior art;

FIG. 34 is a block diagram of a CRUD structure and process flow according to the platform of FIG. 1;

FIGS. 35A to 35E are examples of data inputted into the software development platform of FIG. 1; and

FIG. 35F is an example of a feature of a customised software product outputted by the software development platform of FIG. 1 based on the inputted client data of FIGS. 35A to 35E.

### DETAILED DESCRIPTION

Where applicable, steps or features in the accompanying drawings that have the same reference numerals are to be considered to have the same function(s) or operation(s), unless the contrary intention is expressed or implied.

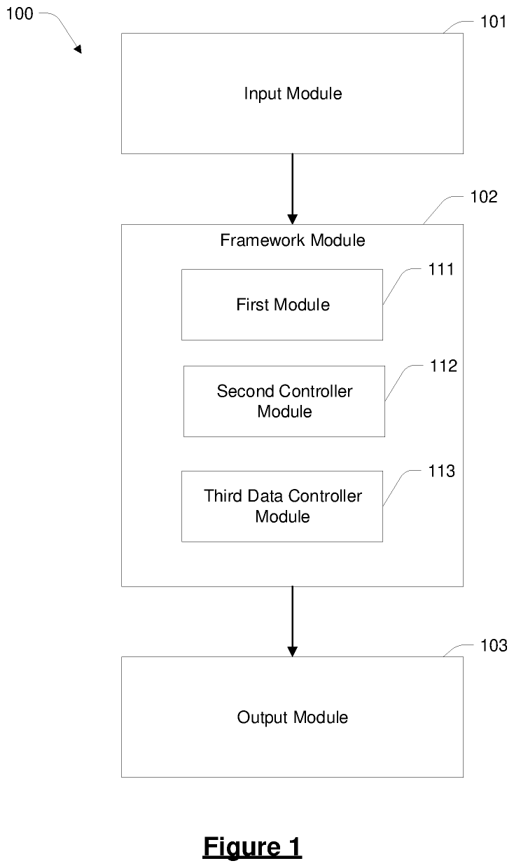

Referring to FIG. 1, there is illustrated a software development platform 100 for creating a customised software product. Platform 100 includes an input module 101 for facilitating input of client data, wherein the client data includes: data in a first programming language wherein the first programming language is HyperText Markup Language (HTML); data in a second programming language wherein the second programming language is JavaScript (JS); and data in a third programming language wherein the third programming language is Java. Platform 100 further includes a framework module 102 including: a first programming language module 111 including framework data in HTML and for receiving the inputted client data in HTML; a second intermediate controller module 112 including framework data in JS and for receiving the inputted client data in JS; and a third centralised data controller module 113 including framework data in Java and for receiving the inputted client data in Java. Further, first, second and third modules 111, 112 and 113 are operatively associated with each other such that, based on the inputted client data, the customised software product is generated. Platform 100 further includes an output module 103 for outputting and displaying the generated customised software product for future access and use.

In an embodiment, input module 101 and output module 103 are an integrated general communications module that includes both the inputting and outputting functionality of input module 101 and output module 103 respectively. Further, it will be appreciated that in preferred embodiments, input module 101 is also configured to receive inputted data other than in HTML.

Looking at the architectural pattern of platform 100, it follows the MVC structure including the major components of:
1) Request Dispatcher: for redirecting the page/data requests;
2) HTML page (which includes input module 101, first module 111 and output module 103): for displaying content to users (output module 103), and receiving inputted client data from users (input module 101);
3) JS data controller (second module 112): for collecting the inputted client data, calling the Java data controller (server logic) (that is, third module 113), receiving a response from the Java data controller, and updating content in the HTML page (using RESTful architecture);
4) Java data controller (Server logic) (third module 113): for validating the inputted client data, calling the data access object (DAO) to query database (relational database), running extra logic to process the database records, encapsulate the data into rendering object (for being rendered as JavaScript Object Notation or JSON), and returning the rendering object to the JS data controller (using RESTful architecture); and
5) Java object/model: for defining the database in object-oriented (OO) language (transform from OO language to relational database, that is, another language).

The major components above correlate to the MVC structure as follows:
Model (M) component comprises 5) Java object/model;
View (V) component comprises 2) HTML page and partially 3) JS data controller; and
Controller (C) component comprises partial 3) JS data controller and 1) Request Dispatcher (it will be appreciated that the controller component for known systems only comprises 1) Request Dispatcher and, as such, the data processing structure and flows differs for platform 100 over existing systems).

The remaining component, 4) Java data controller, relates to business logic, along with 3) JS data controller.

Each of first, second and third modules 111, 112 and 113 refer to both software and hardware for storing and accessing data of each respective one of first, second and third modules 111, 112 and 113. It will be appreciated that the software and in particular the hardware components of first, second and third modules 111, 112 and 113, in some embodiments will overlap across the modules, in other embodiments will be completely common across the modules (for example, the hardware storage will be common for any two or all three first, second and third modules 111, 112 and 113).

For platform 100 to be utilised, a server environment must be set up upon which platform 100 can be deployed. The server environment is set up through the following steps:
1. Configure a server with an operating system such as Ubuntu 14.4 on Linux.
2. Install a database system such as PostgreSQL 9.5 (postgresql-9.5), which is installed as follows:
   a. Create the “pgdg.list” by the following two commands:
      sudo touch/etc/apt/sources.list.d/pgdg.list
      sudo vi/etc/apt/sources.list.d/pgdg.list
   b. Input the following code into pgdg.list #:
      #PostgreSQL repository
      deb http://apt.postgresql.org/pub/repos/apt/trusty-pgdg main
   c. Import a repository signing key, and update package lists:
      sudo wget—quiet-O-
      https://www.postgresql.org/media/keys/ACCC4CF8.asc|\
   And the following will be displayed:
      >sudo apt-key add-
      ok
   d. Run the following commands to update “apt-get” and install and unzip postgresql-9.5:
      sudo apt-get update
      sudo apt-get install postgresql-9.5
      sudo apt-get install unzip
3. Modify a password of a PostgreSQL default user (postgres) (note: not Linux user) which is carried out as follows:
   a. Run the following command:
      sudo-u postgres psql
   b. Under the postgresql command line, run the following command:
      postgres= #ALTER USER postgres WITH PASSWORD ‘postgres123’;
   c. Then quit postgresql through the following command:
      postgres= #\q
4. Modify a password of a Linux user (postgres) which is carried out as follows:
   a. Run the following command to clear the password for the user postgres:
      sudo passwd-d postgres
   b. Run the following command to set the new password:
      sudo-u postgres passwd
   c. Then follow the command prompts to reset password:
      Type new Unix password:
      Retype new Unix password:
      Passwd: successfully reset.
5. Configure PostgreSQL database which is carried out as follows:
   a. Run the following command to open configuration file postgresql.conf:
      sudo vi/etc/postgresql/9.5/main/postgresql.conf
   b. Then change (by pressing “shift+i”): #listen_addresses=‘localhost’
   To the following:
      listen_addresses=‘*’
   c. Enable password by uncommenting the following: #password_encryption=on
   To the following:
      password_encryption=on
   d. Save the file and quit (by typing “: wq” and then pressing enter).
   e. Run the following command to open configuration file pg_hba.conf:
      sudo vi/etc/postgresql/9.5/main/pg_hba.conf
   f. Then add the following contents at the end (by pressing “shift+i”)
      #to allow your client visiting postgresql server
      host all all 0.0.0.0 0.0.0.0 md5
   g. Change the following:
      “local all postgres peer”
   To the following:
      “local all postgres md5”
   h. Save the file and quit (by typing “: wq” and then pressing enter).
   i. Restart the PostgreSQL database through the following command:
      sudo/etc/init.d/postgresql restart
6. Configure the server environment which is carried out as follows:
   a. Download a basic structural framework such as Play! Framework 1.4.4, which is downloaded from:
      https://downloads.typesafe.com/play/1.4.4/play-1.4.4.zip
   b. Unzip the downloaded file of the Play! Framework through the following command:
      sudo unzip play-1.4.4.zip-d/usr/share/apps/
   c. Create “/etc/init.d” scripts (including play-admin, play-client etc.), for example:

```
#!/bin/sh
### BEGIN INIT INFO
## END INIT INFO
# Path to play install folder
PLAY_HOME=/usr/share/apps/play-1.4.4
PLAY=$PLAY_HOME/play
# Path to the application
APPLICATION_PATH=/usr/system/DEV/client
./lib/lsb/init-functions
case “$1” in
  start)
    echo -n “Starting Play service: ”
    rm -f ${APPLICATION_PATH}/server.pid
    ${PLAY} start ${APPLICATION_PATH} --%dev >/dev/null
    RETVAL=$?
    if [ $RETVAL -eq 0 ]; then
      log_end_msg 0
    else
      log_end_msg 1
    fi
    ;;
  stop)
    echo -n “Shutting down Play service: ”
    ${PLAY} stop ${APPLICATION_PATH} >/dev/null
    RETVAL=$?
    if [ $RETVAL -eq 0 ]; then
      log_end_msg 0
    else
      log_end_msg 1
    fi
    ;;
*)
  echo “Usage: $SCRIPTNAME {start|stop}” >&2
  exit 1
  ;;
esac
exit 0
```

d. Copy “play-admin”/“play-client” scripts into “/etc/init.d”.
e. Create “/etc/rc0.d” through to “rc5.d” containing shut down scripts, under “/etc/init.d/” through the following commands:
   sudo update-rc.d play-admin defaults
   sudo update-rc.d play-client defaults
f. Copy the code distributions (within a file for example projectXX.zip, including various modules for example model, view, security, business, admin, client modules, that will be described in detail further below) to “/tmp/” t, and then unzip projectXX.zip into “/usr/system/DEV/” through the following command:
   sudo unzip projectXX.zip-d/usr/system/DEV/
g. Run the following commands:
   sudo chmod 755/etc/init.d/play-admin
   sudo chmod 755/etc/init.d/play-client
h. Then run the following commands:
   sudo chown root: root/etc/init.d/play-admin
   sudo chown root: root/etc/init.d/play-client
i. Then run the following command:
   sudo chmod+rx/usr/share/apps/play-1.4.4/play
j. Then run the following command:
   export PATH=$PATH:/usr/share/apps/play-1.4.4
k. Give access to build the application (for running the Play! Framework commands) through the following commands:
   sudo chown-R root/usr/system/sudo
   chmod-R 755/usr/system/
7. Install programming software, such as Java 1.8 which is carried out as follows:
   a. Download Java 1.8 under “/tmp/” through the following command: https://www.oracle.com/java/technologies/javase/javase-jdk8-downloads.html
   b. Under “/tmp/”, run the following commands to install Java 1.8: sudo mkdir/opt/jdk
      sudo tar-zxf jdk-8u241-linux-x64.tar.gz-C/opt/jdk/sudo
      rm jdk-8u241-linux-x64.tar.gz
   c. Check if Java 1.8 is installed properly by running the following command:
      java-version
8. Compile the code, which is carried out as follows:
   Under “/usr/system/DEV”, run the following commands for each module:
      play dependencies—clearcache
      play dependencies—sync
      play eclipsify
9. Start the applications, which is carried out as follows:
   Run the following commands to start/stop each web application:
      sudo/etc/init.d/play-XXX start
      sudo/etc/init.d/play-XXX stop

Once a server environment is set up upon which platform 100 can be deployed an empty project from platform 100 can be created. It will be appreciated that the code structure utilised in respect of platform follows the classic MVC software design pattern.

To launch a new customized software product from platform 100, the following steps are followed (inputted through input module 101):
1. Platform 100 will initially include a number of example models that will need to be removed from modules 111, 112 and 113. The following example models in third module 113 (more specifically a business module of third module 113) must be removed:
   com.business.models.Attribute.java
   com.business.models.FormTestEntity.java
   com.business.models.Product.java *
   com.business.models.ProductOrder.java *
2. The following example data rendering objects in third module 113 (the business module) must also be removed:
   com.business.models.rendering.objects.AttributeDataRenderingObject.java com.business.models.rendering.objects.FormTestEntityRenderingObject. java com.business.models.rendering.objects.ProductDataRenderingObject.java * com.business.models.rendering.objects.ProductOrderDataRenderingObject. java *
3. Platform 100 will also initially include a number of example controllers in third module 113 (a web module, for example, admin/client, etc.) that will need to be removed. The following example controllers must be removed:
   controllers.Attributes.java
   controllers.FormTestEntities.java
   controllers.Products.java *
   controllers.ProductOrders.java *
   controllers.EwayPaymentGateway.java *
   controllers. WidgetSamples.java
4. Platform 100 will also initially include a number of example “create, read, update, and delete” (CRUD) HTML files (for example, list.html, XXXFormContents.html, etc.) in first module 111 that will need to be removed. The following example CRUD html files must be removed:
   a. The folder “views/Attributes/”.
   b. The folder “views/FormTestEntities/”.
   c. The folder “views/Products/”.
   d. The folder “views/ProductOrders/”.
5. Platform 100 will also initially include a number of example widget sample html files in the folder “views/Application/” in first module 111 that will need to be removed. As such, the folder “views/Application/” must be removed.
6. Platform 100 will also initially include a number of example logics in “controllers.Application.java” in third module 113 that will need to be removed. The following example logics must be removed:
   a. All Attributes methods.
   b. All FormTestEntities methods.
   c. All Products methods.
   d. All ProductOrders methods.
   e. All widget-related methods.
7. Platform 100 will also initially include a folder “conf/message” in first module 111 that will need to be removed. The following examples within “conf/message” must be removed:
   a. page.main.attributes
   b. page.main.formtestentities
   c. page.main.products
   d. page.main.productorders
   e. All code under:
      ##############attributes (customized) ##############
   f. All code under:
      ##############formtestentities (customized) ##########
   g. All code under:
      ##############productorders (customized) ##############
   h. All code under:
      ##############products (customized) #########
   i. Change “page.main.project.title” to a name of the customised software product as defined by the user.
   j. Change “page.register.slogan . . . ” to one or more slogans of the customised software product as defined by the user.
   k. Change “page.register.slogan.title . . . ” to one or more slogan titles of the customised software product as defined by the user.
8. In “main.html” in first module 111 of platform 100:
   a. There will be present a plurality of nav items that should be removed, for example the following:

<li class=“nav-item #{if
org.apache.commons.lang3.StringUtils.startsWithIgnoreCase(play.mvc.Cont
roller.request.actionMethod, ‘attributes')}active#{/if} ”>
<li class=“nav-item #{if
org.apache.commons.lang3.StringUtils.startsWith(play.mvc.Controller.reque
st.actionMethod,‘formTestEntities')}active#{/if} ”>
*<li class=“nav-item #{if
org.apache.commons.lang3.StringUtils.startsWith(play.mvc.Controller.reque
st.actionMethod,‘products')}active#{/if} ”>
*<li class=“nav-item #{if
org.apache.commons.lang3.StringUtils.startsWith(play.mvc.Controller.reque
st.actionMethod,‘productOrders')}active#{/if} ”>

b. There will be present a plurality of widget sample links that should be removed, for example the following:

```
  <li class=“nav-item #{if
org.apache.commons.lang3.StringUtils.equalsIgnoreCase(play.mvc.Controller.request.action
Method, ‘chartsWidget’)}active #{/if} ”>
    <a class=“nav-link” href=“@{Application.chartsWidget}”>
      <i class=“fa fa-bar-chart” aria-hidden=“true”></i>
      <p>Chart Widgets</p>
    </a>
  </li>
  <li class=“nav-item #{if
org.apache.commons.lang3.StringUtils.equalsIgnoreCase(play.mvc.Controller.request.action
Method, ‘videosWidget’)}active#{/if} ”>
    <a class=“nav-link” href=“@{Application.videosWidget}”>
      <i class=“fa fa-video-camera” aria-hidden=“true”></i>
      <p>Video Widgets</p>
    </a>
  </li>
  <li class=“nav-item #{if
org.apache.commons.lang3.StringUtils.equalsIgnoreCase(play.mvc.Controller.request.action
Method, ‘imagesWidget’)}active#{/if} ”>
    <a class=“nav-link” href=“@{Application.imagesWidget}”>
      <i class=“fa fa-object-group” aria-hidden=“true”></i>
      <p>Gallery Widgets</p>
    </a>
  </li>
  <li class=“nav-item #{if
org.apache.commons.lang3.StringUtils.equalsIgnoreCase(play.mvc.Controller.request.action
Method, ‘mapsWidget’)}active#{/if} ”>
    <a class=“nav-link” href=“@{Application.mapsWidget}”>
      <i class=“fa fa-map” aria-hidden=“true”></i>
      <p>Map Widgets</p>
    </a>
  </li>
  <li class=“nav-item #{if
org.apache.commons.lang3.StringUtils.equalsIgnoreCase(play.mvc.Controller.request.action
Method, ‘tablesWidget’)}active#{/if} ”>
    <a class=“nav-link” href=“@{Application.tablesWidget}”>
      <i class=“fa fa-table” aria-hidden=“true”></i>
      <p>Table Widgets</p>
    </a>
  </li>
  <li class=“nav-item #{if
org.apache.commons.lang3.StringUtils.equalsIgnoreCase(play.mvc.Controller.request.action
Method, ‘vectormapsWidget’)}active#{/if} ”>
    <a class=“nav-link” href=“@{Application.vectormapsWidget}”>
      <i class=“fa fa-map-o” aria-hidden=“true”></i>
      <p>Vector Map Widgets</p>
    </a>
  </li>
  <li class=“nav-item #{if
org.apache.commons.lang3.StringUtils.equalsIgnoreCase(play.mvc.Controller.request.action
Method, ‘documentsWidget’)}active#{/if} ”>
    <a class=“nav-link” href=“@{Application.documentsWidget}”>
      <i class=“fa fa-book” aria-hidden=“true”></i>
      <p>Document Widgets</p>
    </a>
  </li>
```

9. In a folder “/public/images” of third module 113 (the business module), existing images can be removed and if desired replaced with selected images by the user.
10. In a configuration file “conf/application.conf” of third module 113 (the web modules), the following parameters are changed:
   a. application.name
   b. jpda.port
   c. jvm.memory
   d. application.session.cookie
   e. database configuration (to create a database if desired or required)
   f. http.port
   g. email configuration (can be deleted if not required)
11. In alternate embodiments, constants for the customised software product are changed in third module 113 of platform 100:
   com.everlast.constants.EverlastConstants.java
12. Change the cloud storage service end point configuration (in this example, Aliyun OSS is utilised) in third module 113:
   a. ENDPOINT
      private static String ENDPOINT=“oss-cn-hongkong.aliyuncs.com”;
   b. BUCKET_NAME
      private static final String BUCKET_NAME= “everlast-tests”;
   c. OSS client key pair:

public static OSSClient getNewOSSClient( ) {
return new OSSClient(ENDPOINT, “......”, “......”);
}

13. Change the digital asset management file cloud system end point configuration (in this example, Dropbox API service is utilised) in third module 113:
   a. Client Identifier?
      “EMLData/0.0.2”: “Everlast/2.9.8”;
   b. Access key
      me “, “Linux”)? “F_8 . . . . WGUu8”: “Ih4ZX53js. AAA
14. Change interface API parameters, for example Adobe API key (ADOBE_DC_CLIENT_ID) in constants.js within the view module (or material module) in second module 112 of platform 100 from:
   https://console.adobe.io/home
15. In first module 111 Clear the code in “/Application/index.html”, or alternatively, change the code to a desired index page of the user.
16. Remove the folder “/conf/statistics/” in first module 111.

The customised software product includes a number of features that have been deemed as commonly useful and usable for a business, with these features categorised into three broad categories:
1) Model modules, which includes basic database models and their data rendering objects, and utility functions, amongst others;
2) Security modules, which includes user authentication functionality for users of the system functions under the model module; and
3) View modules, which includes general page styles, layouts and the common display functions.

Within the model modules are the following:
basic database models;
basic data rendering objects;
email services;
storage service;
utility models; and
widget data rendering objects.

The basic database models includes one or more of:
an application user account model, for example to record basic application user account information such as username, password, amongst others;
an application user token model, for example to record session and user authentication information;
a base attribute model, to be used as the basis for all attribute models of platform 100;
a file record model, where a file upload creates a file record as part of a digital asset management file cloud system, but the original raw uploaded file is saved in the cloud (for example, using Aliyun cloud service);
a base product model, to be used as the basis for all product models of platform 100; and
a product order model, to be used as the basis for all product order models of platform 100.

The basic data rendering objects includes one or more of:
an application user data rendering object, for rendering application user data from the basic database models (including from application user account models and application user token models);
an attribute data rendering object, for rendering attribute data from the basic database models (including from base attribute model and all other attribute models);
a file data rendering object, for rendering file data from the basic database models (including from file record model);
a product data rendering object, for rendering product data from the basic database models (including from base product model and all other product models); and
a product order data rendering object, for rendering product order data from the basic database models (including from base product order model and all other product order models).

The email services include configuring the email access information including:

# Email
mail.smtp.auth=true
mail.smtp.starttls.enable=true
mail.smtp.host=smtp.gmail.com
mail.smtp.port=587
mail.smtp.user =...@everlast.com.au
mail.smtp.password=xxxx
mail.smtp.connectiontimeout=20000
mail.smtp.timeout=20000
mail.smtp.receiver=......

This feature of the customised software product is able to call the requisite API of platform 100 to send emails with or without an email template.

In some specifically customised alternate embodiments, included in the model modules is payment gateway services which are able to call the requisite API of platform 100 to create payment transactions and interact with payment gateway systems such as the eWay Payment Gateway (https://www.eway.com.au/).

The storage service is implemented to a number of storage service systems such as Aliyun Object Storage Service (OSS), AWS Storage Service and Dropbox API Service, more specifically:
As noted above, platform 100 uses for Aliyun OSS (https://www.alibabacloud.com/products.oss) as the file cloud in most instances;
Platform 100 uses Dropbox API Service as the digital asset management file cloud system;
After specifying an Aliyun OSS client key pair in the client input code, this feature of the customised software products are able to call the requisite API of platform 100 to upload, delete, list, and/or search any types of files (for example, images, documents, videos, etc.) from and to a cloud storage of Aliyun OSS.
Implementation of AWS Storage Service and Dropbox API Service, is similar to the implementation of Aliyun OSS but with differing API key and OSS key configurations.

The utility models includes:
com.everlast.sql.utils.SqlUtil—a utility class to directly access the database by sql without using DAOs, which make the database access more direct and therefore faster.
com.everlast.utils. EverlastUtils—a utility to sort a java map by values, obtain a hash value of a string, obtain the first couple of words in a sentence, and format the validation errors in a human-readable words.
com.everlast.utils.DataScrapingUtils-utility methods to scrape contents from other websites and data sources.
com.everlast.utils.DateRangeUtil-a utility to format the date and associated date ranges, for example to obtain a date string in yyyy/mm/dd (year/month/day) hh: MM (hour: minute), etc.
com.everlast.utils.PropertiesHelper-a utility to obtain configurations defined in a configuration file such as “application.conf”.
com.everlast.utils.ProxiedRequestUtils-internet protocol (IP) utilities.

The widget data rendering objects include a collection of page widget solutions. These features of the customised software products are able to follow the data structures defined by platform 100 and then call corresponding predefined JavaScript methods to show, for example: charts of various types (including but not limited to pie, doughnut, line, and bar); document readers; multimedia galleries; maps with markers and overlays; and data tables, amongst others.

The security modules are utilised if there is a need to have users be registered to the customised software product, and need to sign in or create a profile in order to utilise the product. Within the security modules are the following:
an unauthorised application for new users including functions to register new users and sign in to the customised software product as a registered user of that product; and
an unauthorised application for existing users including when a user logs in by their username and password, and logouts. Moreover, checks are also carried out in regards to a user token and user role (that is, the level of access a user will have depending on their role or status) against an authentication level for an operation.

It will be appreciated that such security modules are not required if there is no need to have users registered and/or user profiles to be created and maintained.

Looking at view modules in more detail, this refers to a number of different modules. For example, in one embodiment of the present code base, the view module template is based from Material Dashboard Pro by Creative Tim (where the templates are found at https:/creative-tim.com/product/material-dashboard-pro-bs4). Modules such as these are referred to as view modules because they are view templates with different page styles and layouts. For each of these, they can be customised, for example, their theme colour can be configured to fit to desired theme colours (such as a company logo colour). Platform 100 is such that the configuration of each dashboard module is done is a consistent fashion in practice using much the same parameter setting code for each.

In another embodiment, a template module is independent from the view module. In this embodiment, the view modules still include all the required plugins and js core logics, and the template module (or material template module) is for integrating, for example, Material Dashboard Pro.

Within the view modules are at least the following:
CRUD HTML input tags;
widget templates in JS; and
third party plugins at least for the following features:
   file uploader;
   system notification;
   system modal window; and
   alert prompts;
A basic HTML to be extended by the customized project HTML page; and
All Cascading Style Sheets (CSS) files.

As indicated above, it will be appreciated that the view modules will utilise additional third party plugin features to those listed above, and indeed a number of third party plugins to provide each feature.

The use of CRUD within platform 100 will be looked at in more detail here. In embodiments of platform 100 in respect of CRUD structure and process flow, input module 101 of platform 100 only receives client data in HTML for the first module 111, as there is no input required for the second and third modules 112 and 113. Second module 112 includes a plurality of pre-programmed code blocks of a second type and third module 113 includes a plurality of pre-programmed code blocks of a third type. It will be appreciated that the second type of pre-programmed code blocks are in JavaScript and the third type of pre-programmed code blocks are in Java. Further, first, second and third modules 111, 112 and 113 are operatively associated with each other such that, based on the inputted HTML client data, framework module 102 automatically utilises one or more of the pre-programmed code blocks of the second type and one or more of the pre-programmed code blocks of the third type to generate the customised software product.

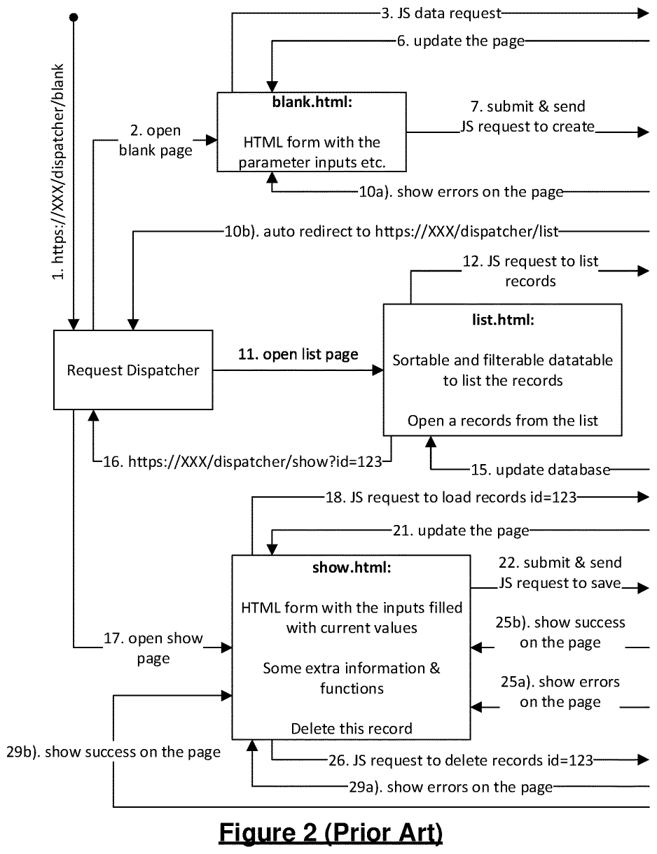

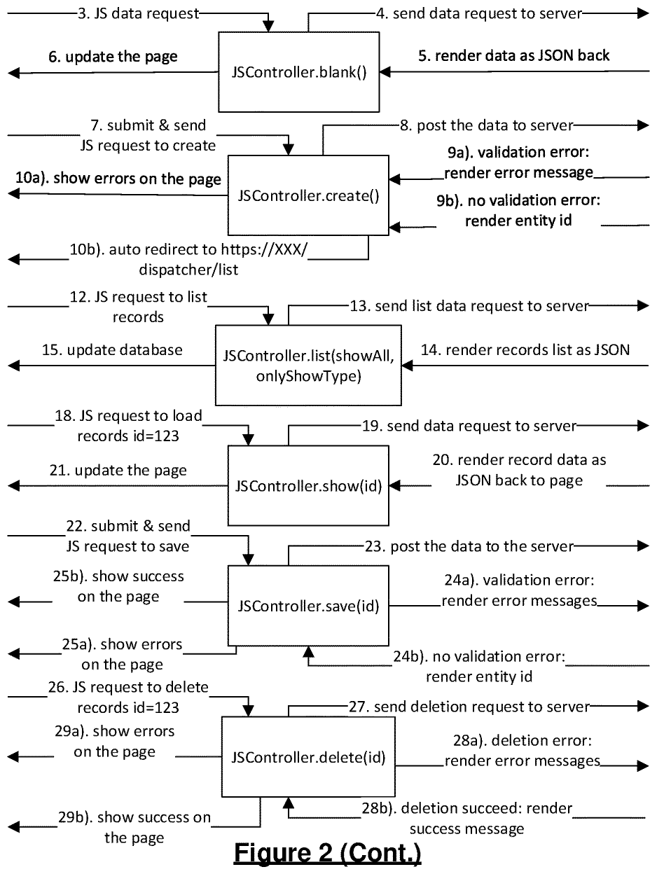

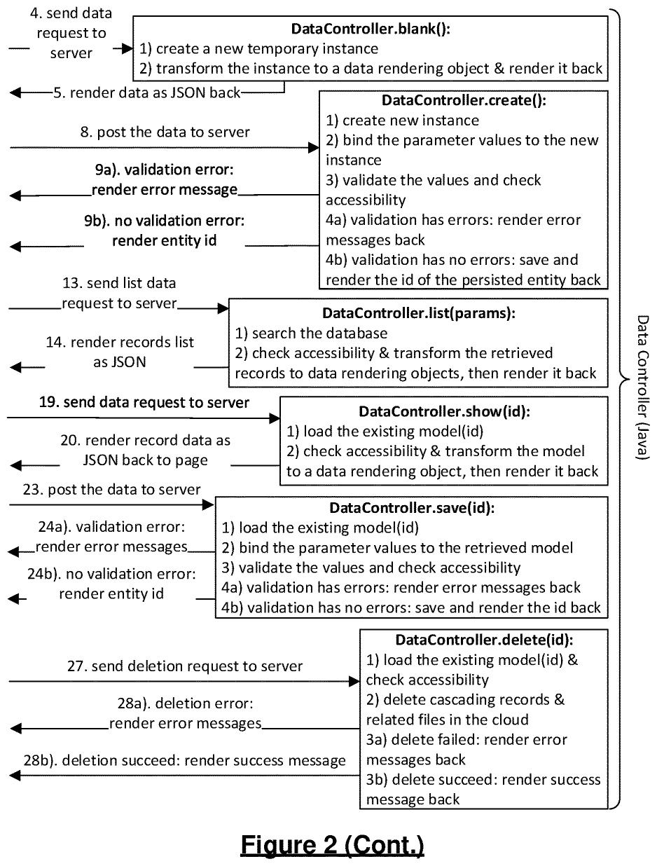

For the purposes of comparison, the CRUD structure and process flow of an existing system of the prior art illustrated in FIG. 2 will be described herein.
1. Request Dispatcher interface is accessed at “https//XXX/dispatcher/blank”.
2. The Request Dispatcher opens a blank page file “blank.html” (HTML form with the parameter inputs etc.).
3. JS data request creates “JSController.blank( )”.
4. A data request is sent to a server (the data controller component in Java language) to create a new temporary instance of “DataController.blank( )”, and transform the instance to a data rendering object.
5. Render data as JSON back to “JSController.blank( )”.
6. Update blank.html with the rendered data.
7. Submit and send JS request to create “JSController.create( )”.
8. Post the data to the server to create a new instance “DataController.create( )”, bind parameter values to the new instance, validate the values and check accessibility, if the validation has no errors: save the ID of the persisted entity.
9a. If the validation has errors: render error messages back to “JSController.create( )”.
9b. If there is no validation errors: render persisted entity ID to “JSController.create( )”.
10a. Following 9a., show errors on the blank.html page.
10b. Following 9b., auto redirect to the Request Dispatcher at “https//XXX/dispatcher/list”.
11. The Request Dispatcher opens a list page file “list.html” (a sortable and filterable datatable that lists the records, and is able to open a record from the list).
12. JS request to list records in file “JSController.list (showAll, onlyShowType)”.
13. A list data request is sent to the server to create file “DataController.list (params)” to search the database based on the search parameters (“params”), and check accessibility and transform the retrieved record list to data rendering objects.
14. Render the retrieved record list as JSON back to “JSController.list (showAll, onlyShowType)”.
15. Update list.html with the rendered retrieved record list.
16. The Request Dispatcher is accessed at “https//XXX/dispatcher/show?id=123”
17. The Request Dispatcher opens a show page file “show.html” (HTML form with the inputs filled with current values, some extra information and functions, delete this record).
18. JS data request then loads “record id=132” to create “JSController.show(id)”.
19. A data request is sent to the server to create file “DataController.show(id)” to load an existing model(id), check accessibility and transform the model to a data rendering object.
20. Render record data as JSON back to “JSController.show(id)”.
21. Update show.html with the rendered record data.
22. Submit and send JS request to save as file “JSController.save(id)”.
23. Post the data to the server to create file “DataController.save(id)” to load the existing model(id), bind the parameter values to the retrieved model, validate the values and check accessibility, if the validation has no errors: save the id.
24a. If the validation has errors: render error messages back to “JSController.save(id)”.
24b. If there is no validation errors: render entity ID to “JSController.save(id)”.
25a. Following 24a., show validation errors on the show.html page.
25b. Following 24b., show validation success on the show.html page.
26. JS request to delete record id=123 in file “JSController.delete(id)”.
27. A deletion request is sent to the server to create file “DataController.delete(id)” to load the existing model(id) and check accessibility, delete cascading records and related files stored in cloud storage.
28a. If the deletion failed: render error messages back to “JSController.delete(id)”.
28b. If the deletion is successful: render success messages back to “JSController.delete(id)”.
29a. Following 28a., show deletion errors on the show.html page.
29b. Following 24b., show deletion success on the show.html page.

From the steps set out above, broadly speaking, when introducing a new database model using the prior art system of FIG. 2, the is a need to:
1) Define the database model/table schema by Java object (for example, Hibernate model);
2) Define the rendering object for rendering the model instance;
3) Write the controller dispatcher;
4) Write the HTML form and its layout/styles for blank page, existing show page, record list page etc.
5) Write JavaScript data controller to handle data requests and responses from the server.
6) Write Java data controller to handle data requests, query the data records from the database, validate the data inputs, check the accessibility, render the objects back and so on.

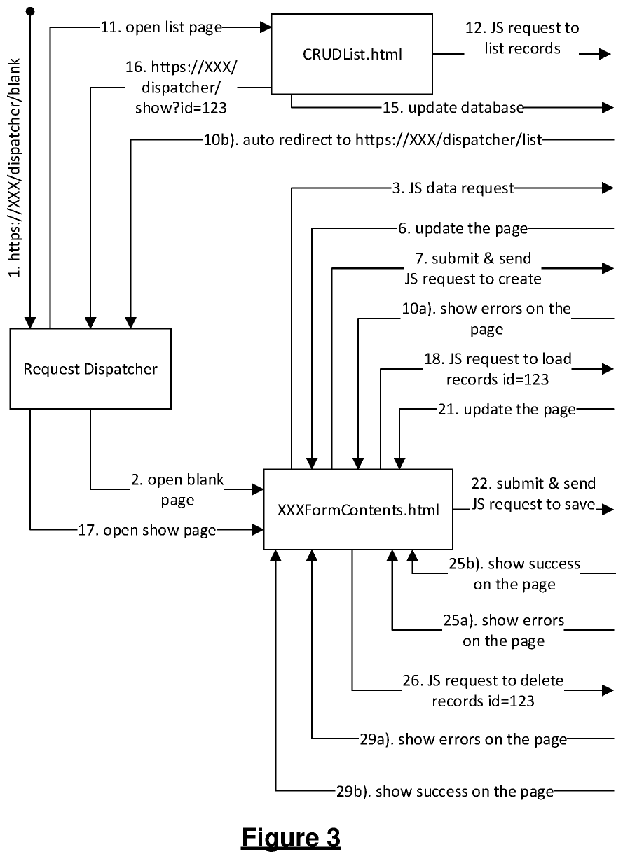

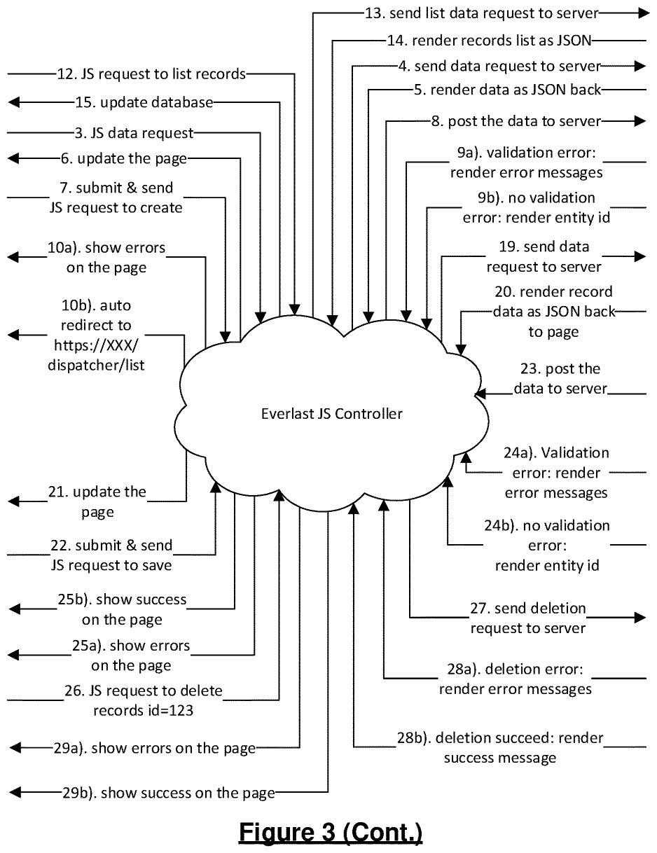

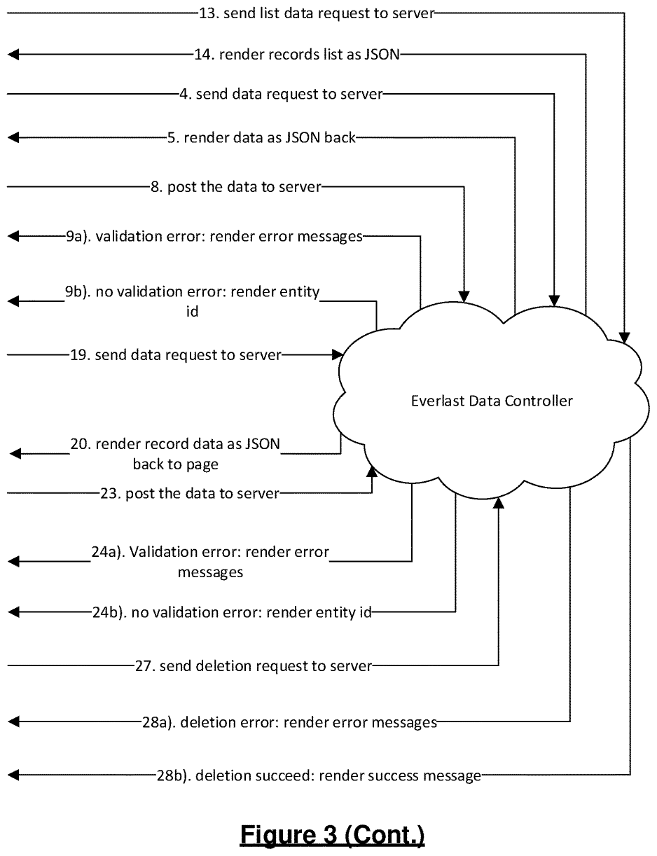

Referring now to FIG. 3, there is illustrated an implementation of a process for use of platform 100 for implementing a CRUD model through input module 101.
1. Request Dispatcher interface is accessed at “https//XXX/dispatcher/blank”.
2. The Request Dispatcher opens a blank page file “XXXFormContents.html” (HTML form with the parameter inputs etc.) within first module 111.
3. JS data request is made to an embodiment of second controller module 112 labelled “Everlast JS Controller” in FIG. 3.
4. A data request is sent to an embodiment of third data controller module 113 labelled “Everlast Data Controller” server of FIG. 3.
5. Render data as JSON back to the Everlast JS Controller.
6. Update XXXFormContents.html file within first module 111 with the rendered data.
7. Submit and send JS request to a create function in the Everlast JS Controller.
8. Post the data to the Everlast Data Controller server.
9a. If the validation of values of the data has errors: render error messages back to the Everlast JS Controller.
9b. If there is no validation errors: render entity ID to Everlast JS Controller.
10a. Following 9a., show errors on page of the XXXFormContents.html file within first module 111.
10b. Following 9b., auto redirect to the Request Dispatcher at “https//XXX/dispatcher/list”.
11. The Request Dispatcher opens a list page file “CRUDList.html” within first module 111 for a database.
12. JS request to list records in the Everlast JS Controller.
13. A list data request is sent to the Everlast Data Controller server.
14. Render the record list as JSON back to the Everlast JS Controller.
15. Update database through CRUDList.html within first module 111.
16. The Request Dispatcher is accessed at “https//XXX/dispatcher/show?id=123”.
17. The Request Dispatcher opens a show page in XXXFormContents.html file within first module 111.
18. JS data request then loads “record id=132” to the Everlast JS Controller.
19. A data request is sent to the Everlast Data Controller server.
20. Render record data as JSON back to the Everlast JS Controller.
21. Update XXXFormContents.html within first module 111 with the rendered record data.
22. Submit and send JS request to save within the Everlast JS Controller.
23. Post the data to the Everlast Data Controller server.
24a. If the validation of values of the data has errors: render error messages back to the Everlast JS Controller.
24b. If there is no validation errors: render entity ID to the Everlast JS Controller.
25a. Following 24a., show validation errors on the XXXFormContents.html page within first module 111.
25b. Following 24b., show validation success on the XXXFormContents.html page within first module 111.
26. JS request to delete record id=123 in the Everlast JS Controller.
27. A deletion request is sent to the Everlast Data Controller server.
28a. If the deletion failed: render error messages back to the Everlast JS Controller.
28b. If the deletion is successful: render success messages back to the Everlast JS Controller.
29a. Following 28a., show deletion errors on the XXFormContents.html page within first module 111.
29b. Following 24b., show deletion success on the XXFormContents.html page within first module 111.

From the steps set out above, broadly speaking, when introducing a new database model using platform 100 as illustrated in FIG. 3, the is only a need to:
1) Define the database model/table schema by Java object (for example, Hibernate model) and annotate some parameters.

One example is shown as follows (where “dataRenderObject” is defined as a class):

```
@EntityConfigurations(
  dataRenderingObject = FormTestEntityRenderingObject.class,
  fileWriterPrefix = FormTestEntity.FORMTESTENTITY_FILE_WRITER_PREFIX,
  fileTypes = {FormTestEntity.FORMTESTENTITY_FILE_TYPE},
  extraValidations = { }
  listOrderBy = “testText”,
  listOrder = listOrder.ASC,
  listSearchBy = “testType”
)
In another embodiment, an example is shown as follows (where “dataRenderObject”
is defined as a string):
@EntityConfigurations(
  dataRenderingObject =
“com.business.models.rendering.objects.FormTestEntityRenderingObject”,
  fileWriterPrefix =
FormTestEntity.FORMTESTENTITY_FILE_WRITER_PREFIX,
  fileTypes = {FormTestEntity.FORMTESTENTITY_FILE_TYPE},
  extraValidations = { },
  listOrderBy = “testText”,
  listOrder = “ASC”,
  listSearchBy = “testType”
)
```

2) Define the rendering object for rendering the model instance;
3) Write the controller dispatcher; and
4) Write the HTML with all form contents and a record list page.

As such, for CRUD for platform 100 compared to the prior art system of FIG. 2, there is no need to code the JavaScript data controller (that is, second module 112 in this embodiment being Everlast JS Controller is pre-programmed for immediate use) or Java data controller (that is, third module 113 in this embodiment being Everlast Data Controller server is pre-programmed for immediate use) which are the most complex pieces of code in the prior art system of FIG. 2. It will be appreciated that in some very rare cases where more logics are required, there will be a need to re-program the Java data controller, but in these rare cases this will only require very minor alteration of the Java code.

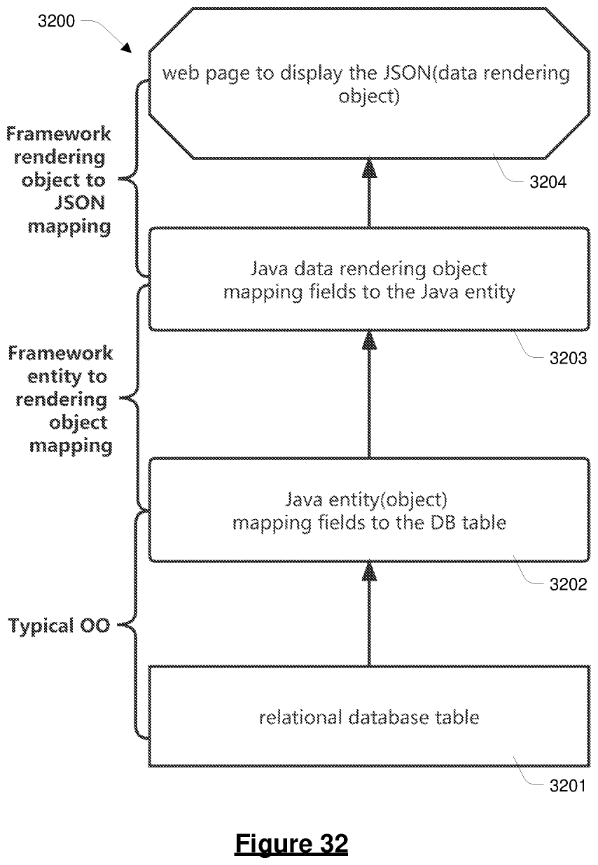

Referring to FIG. 32, the encapsulation and flow of data from platform 100 is illustrated at reference 3200. Firstly, at 3201, a relational database table (for example, an SQL database) where a Java entity maps object fields to the relation database table at 3202. Such mapping, in itself, is well-known in object-oriented programming. Next, at 3203, inputted client data rendering object in Java (as received by module 113) renders the mapped object fields to the Java entity. Finally, at 3204, a JSON data rendering object is mapped to the Java data rendering object so that the HTML page is displayed.

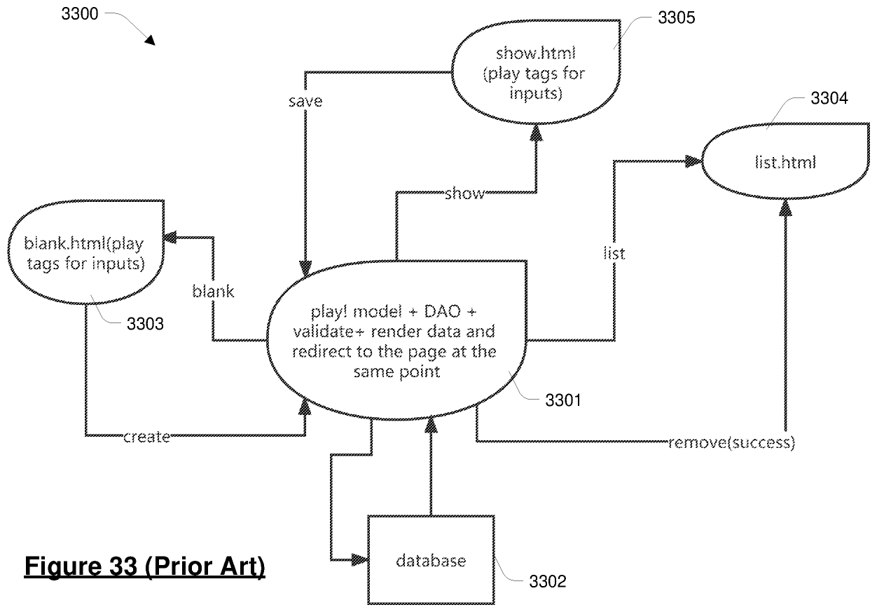

Referring to FIG. 33, for the purposes of comparison, the structure and process flow of an existing framework of the prior art (Play! Framework 1.x) is illustrated (it is noted that Play! Framework 1.x uses unrestful CRUD, therefore it renders the data and redirect page at the same point) and will be described herein at 3300. This existing CRUD framework extends the play.db.jpa.Model support class, and then a request dispatcher 3301 reads data from a database 3302 and then calls a blank page file “blank.html” 3303 (corresponding to step 2. of FIG. 2), a list page file “list.html” 3304 (corresponding to step 11. of FIG. 2), and a show page file “show.html” 3305 (corresponding to step 17. of FIG. 2). In response to the call of “blank.html” 3303, the blank page is created based on play! Tag inputs (corresponding to step 3. of FIG. 2). In response to the call of “show.html” 3305, the show page file is updated with the rendered data based on the play! inputs and saved (corresponding to steps 21. and 22. of FIG. 2). Finally, and the removal or deletion of a record is also made by request dispatcher 3301 (corresponding to steps 26., 27., 28b. and 29b. of FIG. 2). As such, the above call methods cause request dispatcher 3301 to: read data from database 3302; bind data; validate data; return an object for rendering; and redirect to the rendered page at the same point. The page can then be displayed with the data in a play! predefined page. Whilst 3300 involves integrated of functions, it is only able to work in respect of web applications and does not support modern system structures as it makes any customization of the page (for example, with more styles, layouts or additional page functions) very difficult. Contributing to this is the dataflows in the known integrated systems being difficult to track.

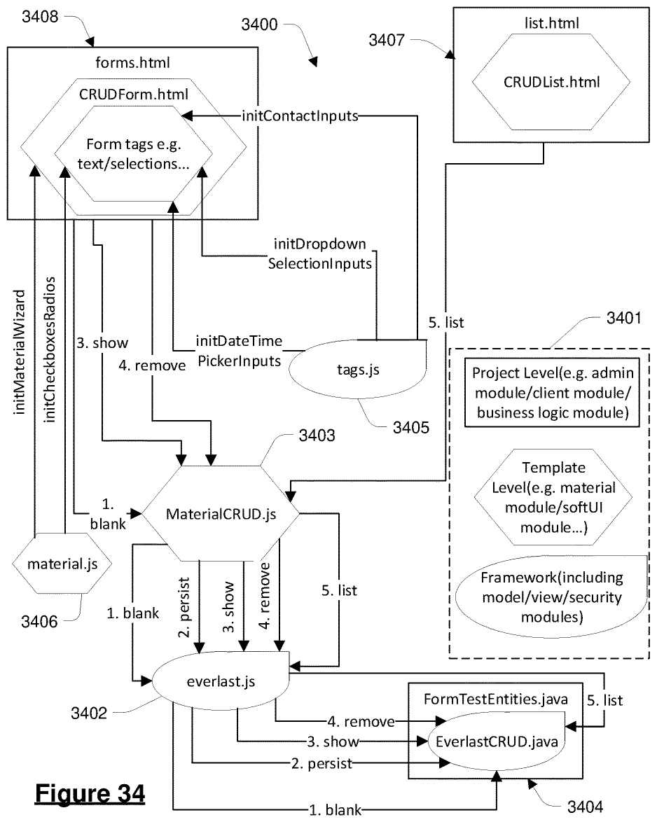

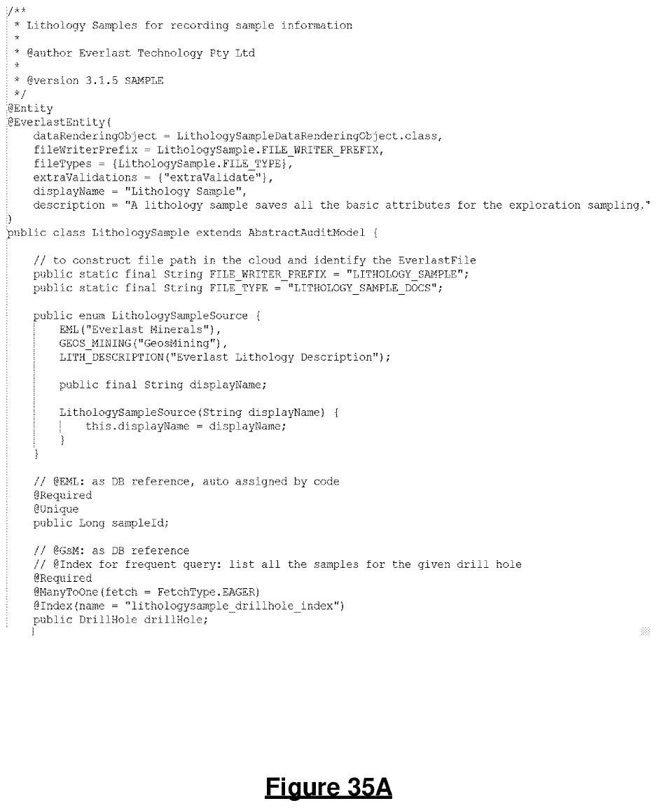

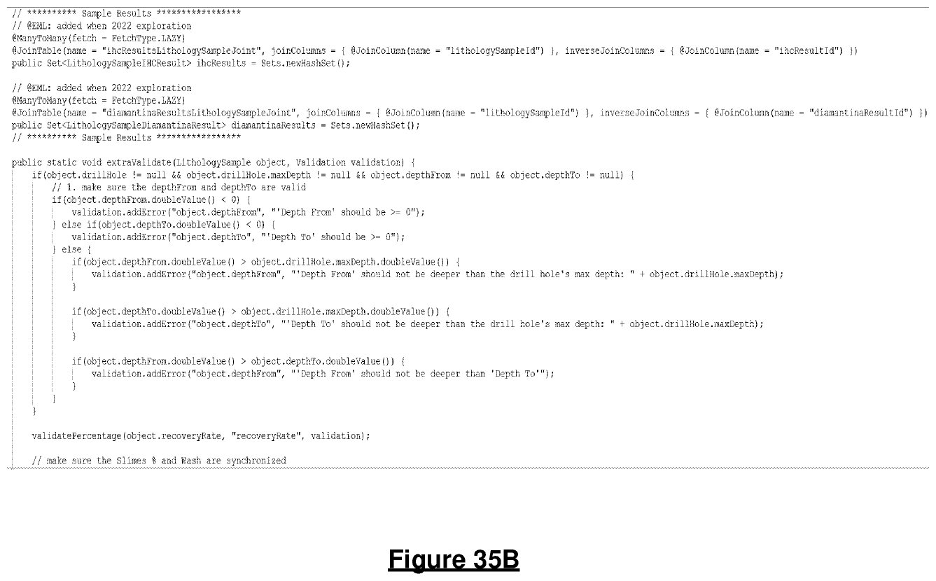

Referring now to FIG. 34, an implementation of a process for use of platform 100 for implementing a CRUD model is illustrated (a simplified alternate representation of FIG. 3) and will be described herein at 3400. As noted in 3400 at legend 3401: the rectangular elements refer to project level elements (such as admin module, client module, business logic module etc.), the hexagonal elements refer to template level elements (such as material module, etc.), and the teardrop shaped elements refer to framework level elements (such as model/view/security modules). 3400 illustrates a preferred embodiment of JS data controller that comprises the “everlast.js” element 3402 (indicated by legend 3401 as a framework level element) and the “MaterialCRUD.js” element 3403 (indicated by legend 3401 as a template level element), where:
“everlast.js” element 3402 is where platform 100 handles the “blank”, “persist”, “show”, “remove” and “list” requests from pages denoted by 3407 and 3408 and kicks off AJAX call to the Java data controller; and
“MaterialCRUD.js” element 3403 is the view module template (based on Material Dashboard) and customized call to the “everlast.js” CRUD methods, with form wizard functions etc.

An example of the Java data controller (which illustrates the use of the platform 100) is the “FormTestEntities.java” element (indicated by legend 3401 as a project level element) which extends “EverlastCRUD.java (indicated by legend 3401 as a framework level element) and controls an example model (referred to above FormTestEntity.java), collectively denoted by reference 3404, which carries out the following functions:
1. Reads/writes data from/to the database (relation database);
2. Binds the data from the HTTP request from the request dispatcher;
3. Validate, that is, register the method in @EverlastEntity annotation (discussed further below);
4. Map to its data rendering object, defined as above and illustrated in FIG. 32, and register the class in @EverlastEntity annotation;
5. Render error as JSON if validation fails; and
6. Render the JSON data (mapped by data rendering object in step 4.) back to the JS data controller (referred to as the “front end”).

Other main elements of 3400 are as follows:
“tags.js” element 3405 (indicated by legend 3401 as a framework level element) which initiates input functions (CRUD input tags, explained in more detail below, for example, a date picker, time picker, telephone/mobile telephone number input, etc.);
“material.js” element 3406 (indicated by legend 3401 as a template level element) is the view module template (based on Material Dashboard) including customized wizard form;
“CRUDList.html” element (indicated by legend 3401 as a template level element) which is extended by the highly customised “list.html” element (indicated by legend 3401 as a project level element), collectively denoted by reference 3407. The “CRUDList.html” element is the view module template (based on Material Dashboard) including data record lists, data tables with sorting, filters, etc. (which can be extended for each entity CRUD operation); and
“CRUDForm.html” element (indicated by legend 3401 as a template level element) which is extended by the “form.html” (indicated by legend 3401 as a project level element), collectively denoted by reference 3408: template based (we use material dashboard templates) data form, including the input tags (“form tags” template element) for each entity field (which can be extended for each entity CRUD operation).

The implementation of CRUD of 3400 provides numerous technical advantages over known systems (such as 3300) including at least the following reasons:
Separates the page dispatcher and data request controllers, as well as running the logic processes asynchronously, which enables it to support different kinds of applications (for example, web, mobile etc.)
Template based solutions enable simple customised UIs including styles, layouts and additional page functions/plugins, amongst others.
Clearer data flows, which enable developers to more easily track flows and debug.
Annotation defined in models and data rendering objects for CRUD, providing user with easier understanding and less coding from scratch.
Easy to extend with more page functions and plugins, for example, by adding the plugin code in “tags.js” or “material.js”.

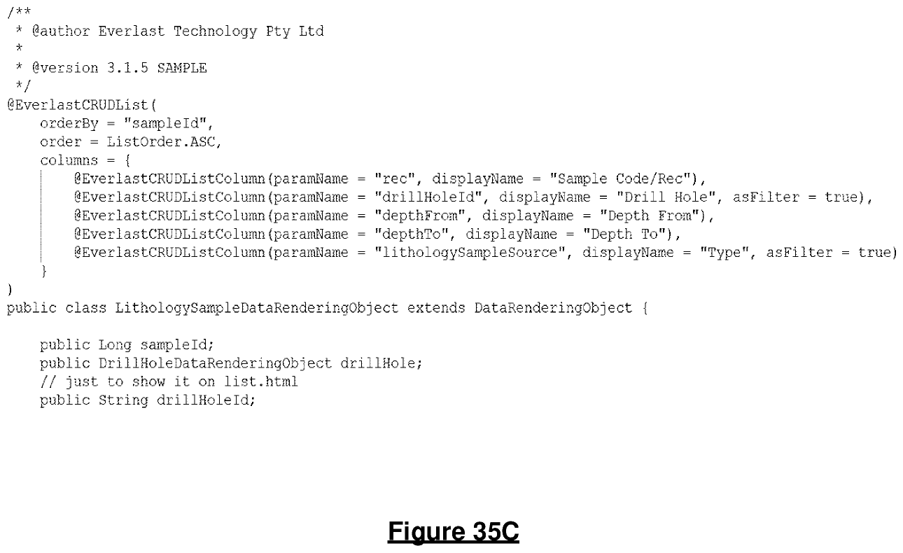

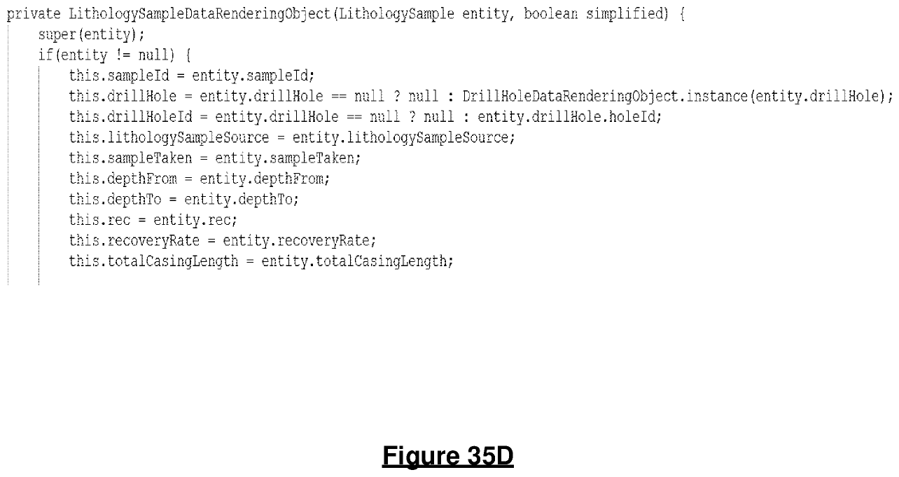

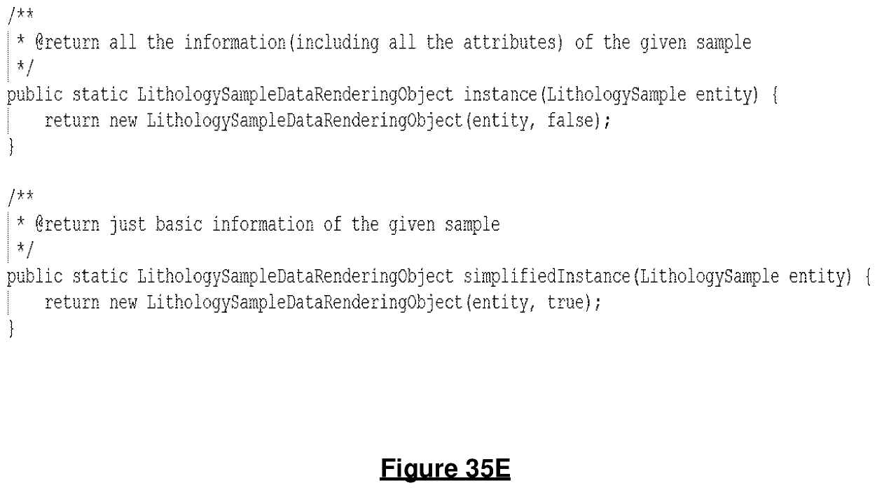

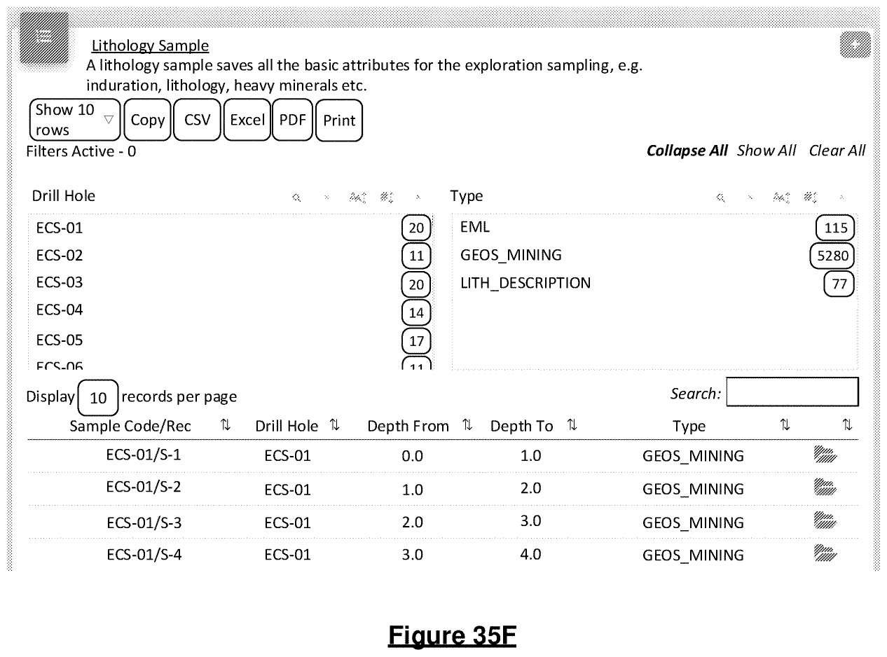

An example data rendering of a feature of the customised software products outputted from platform 100 shown in FIG. 35F (which is an example of a displayed auto-populated data table provided by the @EverlastCRUDList annotation), with an example of the client input data code inputted into platform 100 shown in FIGS. 35A to 35E. In this example, a database model (a Java objection to map to a relational database table) may be defined. The known Play! Framework includes @entity framework annotation that defines entities mapped to a database table. Platform 100 provides an extension to @entity of the Play! Framework referred to herein as @EverlastEntity framework annotation where a user is able to define entity attributes, those attributes including (found in the code of FIG. 35A):
1. “dataRenderingObject”: which is used to set the rendering object class for rendering the database record of this entity to the front end.
2. “fileWriterPrefix”: which is used to set the document attachment path prefix for this entity, for example:
https://everlast-prod.XXX.com/1/LITHOLOGY_SAMPLE_159/LITHOLOGY_SAMPLE_DOCS/XXX.JPEG
3. “fileTypes”: which is used to set the document attachment path file type for this entity, for example:
https://everlast-prod.XXX.com/1/LITHOLOGY_SAMPLE_159/LITHOLOGY_SAMPLE_DOCS/XXX.JPEG
4. “extraValidations”: which specifies the validation methods when saving a record of this entity.
5. “displayName”: which is used to set the display name of this entity and its data records, as will be shown in CRUD pages.
6. “description”: which is used to set a description of this entity and its data records, as will be shown in CRUD pages.

The example code of FIGS. 35A and 35B show how the @EverlastEntity annotation works in a model declaration, the annotation defining the saving, rendering and validation parameters. More particularly, the example code of FIG. 35A relates to, amongst others, the title and subtitle text of the example of FIG. 35F as well as the “Type” field, the specific types of drill holes within that field retrieved from a file from a specified file path. The example code of FIG. 35B relates to, amongst others, the data from the displayed table of data records (at the bottom of the example of FIG. 35F) in particular validating the displayed data records to ensure there are no errors in the data displayed.

Another example is provided of the following framework model referred to as “com.everlast.models.abstracts.AbstractAuditModel” which is framework “super model” derived and extended from a Play! model “AbstractAuditModel” but highly customized to include, amongst others, the following features:
1. “supervisorLogin”: which is used to implement that any data record of any entity in platform 100 must save a recognised supervisor account who creates this data record;
2. “createDate”: which is used to implement that any data record of any entity in platform 100 must save the time stamp when creates this data record;
3. “lastModifiedUser”: which is used to implement that any data record of any entity in platform 100 must save the user that updates the data record;
4. “lastModifiedDate”: which is used to implement that any data record of any entity in platform 100 must save the date when the data record is updated; and
5. “active”: which is used to implement that any data record of any entity in platform 100 must keep a flag to indicate if the data record is accessible.

The example code of 35C shows how the @EverlastCRUDList annotation works in the data rendering object, the annotation defining the list/search CRUD behaviour. This example code more specifically relates to, amongst others, the data from the displayed table of data records (at the bottom of the example of FIG. 35F). More specifically, platform 100 provides an extension the Play! Framework referred to herein as @EverlastCRUDList framework annotation where a user is able to define CRUD list attributes, those attributes including (found in the code of FIG. 35C):
1. an “orderBy” attribute, which allows the data of the table of FIG. 35F to be listed according to a chosen field (from the heading of each column);
2. an “order” attribute, which is one of an ascending order “ASC” or a descending order “DESC”; and
3. a “columns” attribute, which is from the @EverlastCRUDListColumn framework annotation that defines the data fields to show for each column of the table of FIG. 35F.

The @EverlastCRUDListColumn framework annotation is provided by platform 100 where a user is able to define the CRUD list column attributes (that is, each column heading of the table of FIG. 35F), those attributes including (found in the code of FIG. 35C):
1. a “paramName” attribute, which is the parameter name in this rendering object;
2. a “displayName” attribute, which is the column heading (or field) displayed in the table of FIG. 35F (the CRUD list); and
3. an “asFilter” attribute, which defines whether a field should be a filter for the data displayed in the table of FIG. 35F (the CRUD list), where in this example, “Drill Hole” and “Type” fields are selectable filters.

The example code of FIG. 35D shows the code structure of a data rendering object, and more specifically renders the data from the relevant entity file (for “LithologySample”) by mapping the relevant fields of the file as the presently displayed field to display the example of FIG. 35F.

The example code of FIG. 35E shows how to initiate a data rendering object from a database model, more specifically enabling two types of displays of data to be rendered: a full display returning all information of a given sample including all attributes; or a simplified display returning only a subset of the information of a given sample.

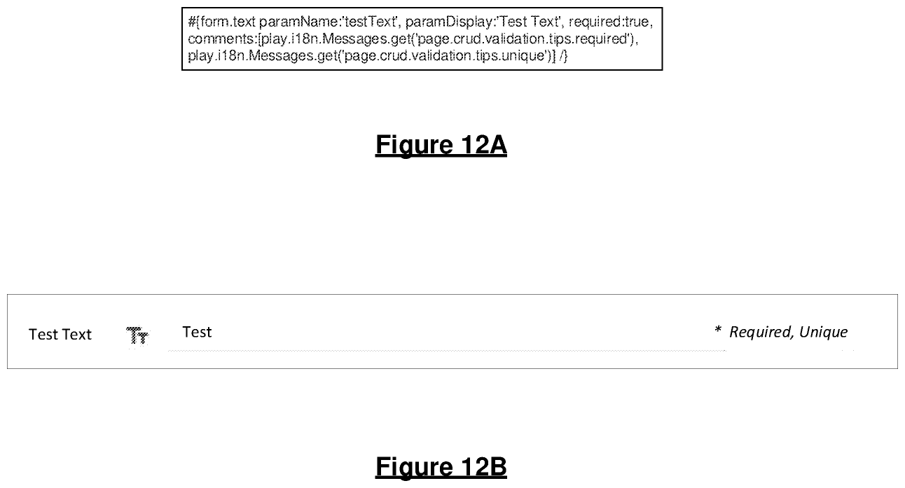

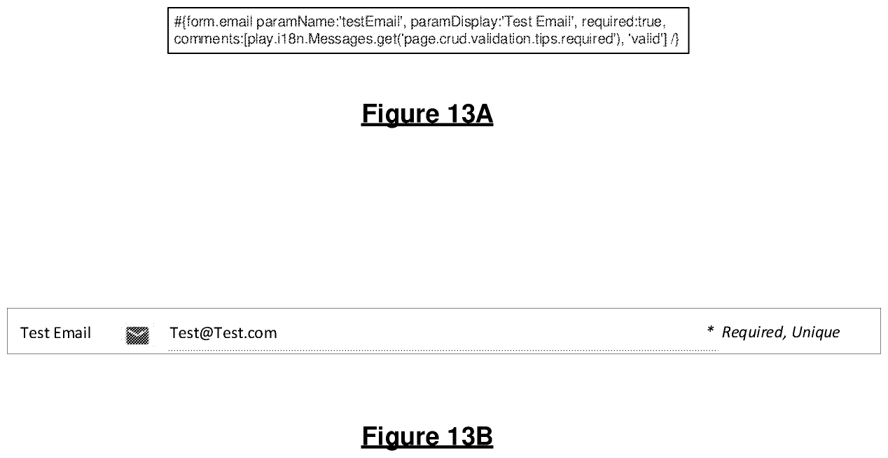

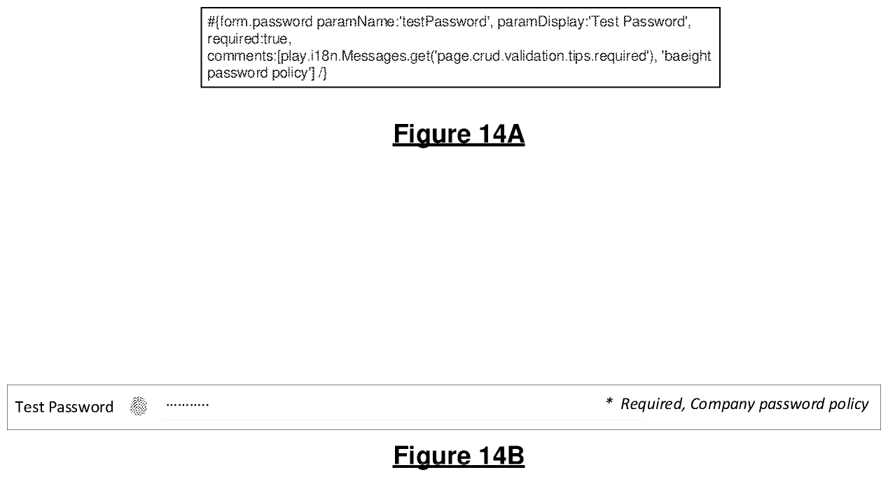

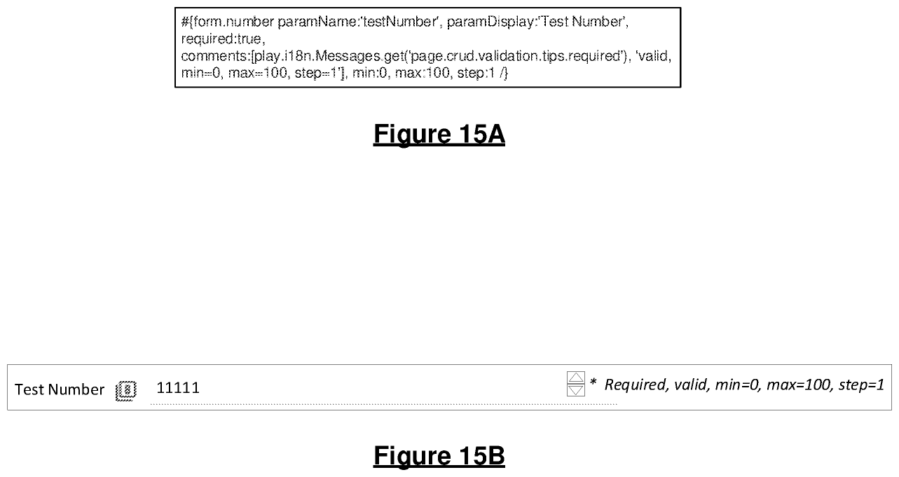

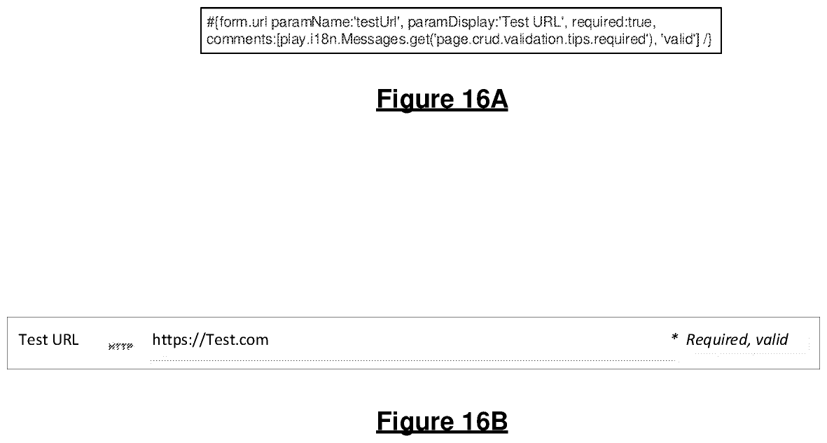

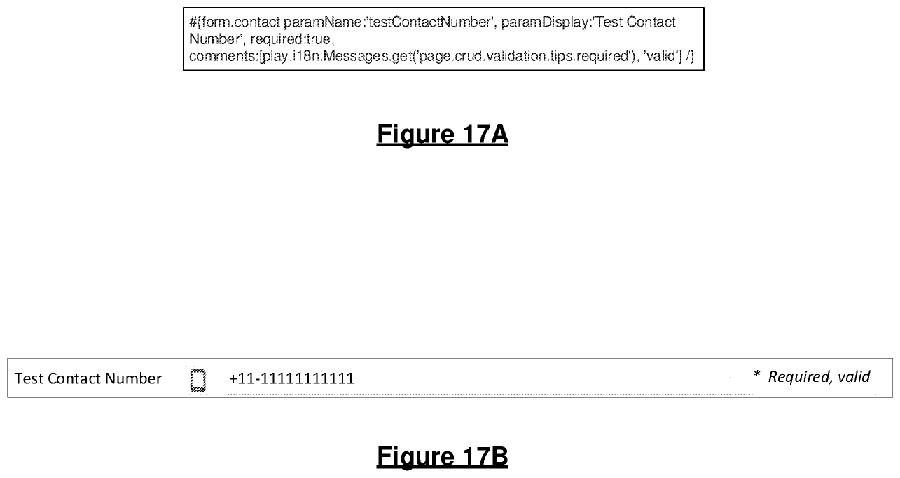

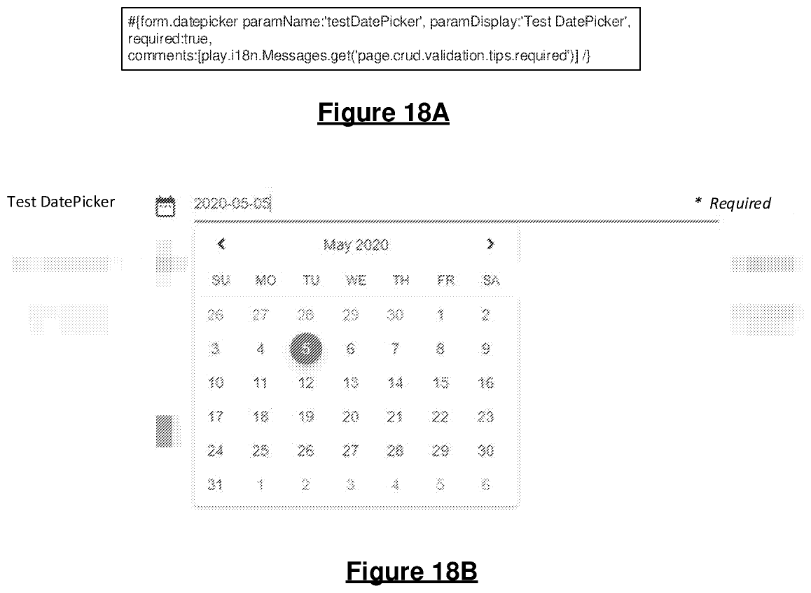

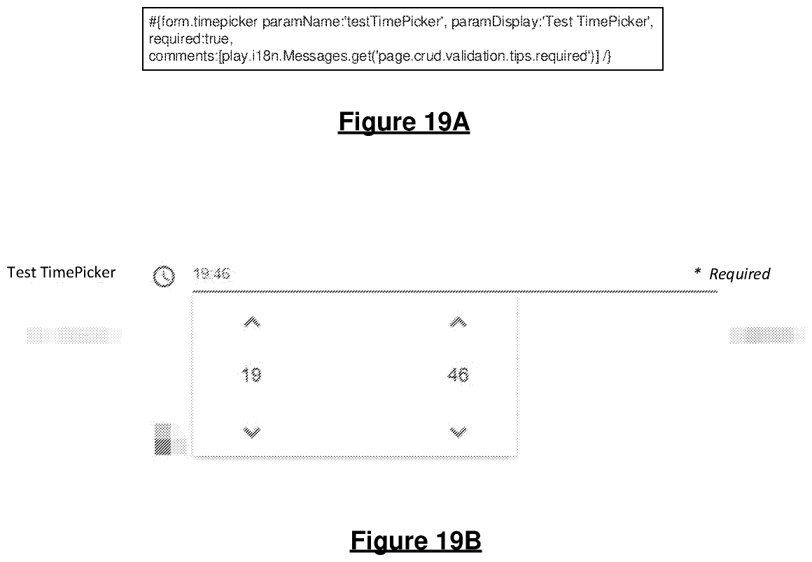

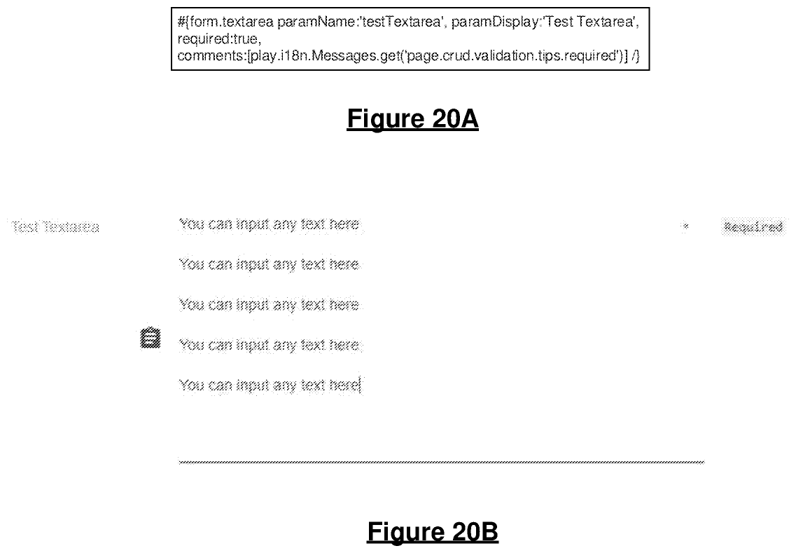

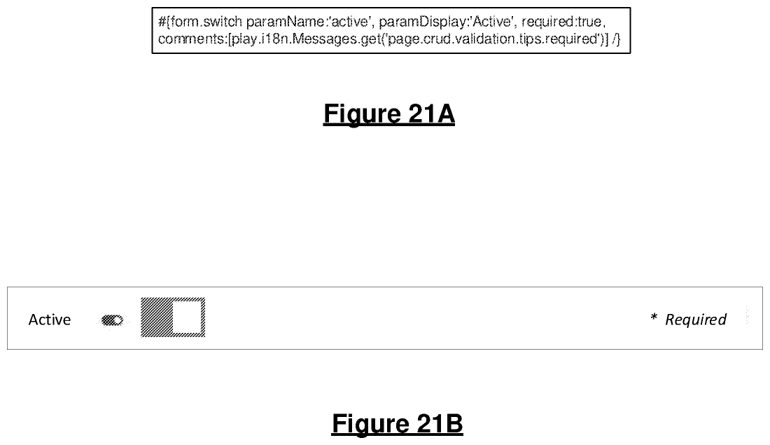

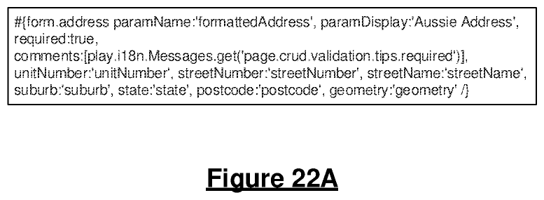

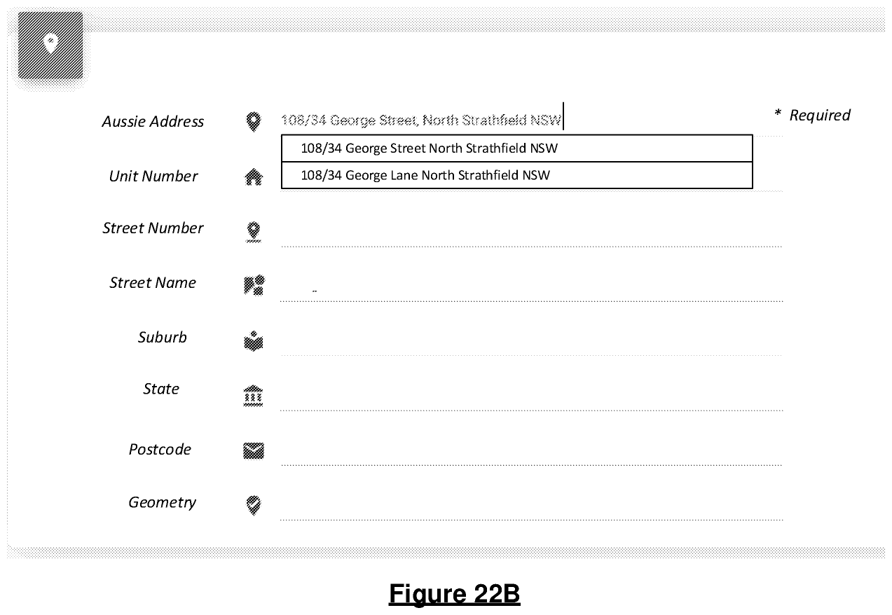

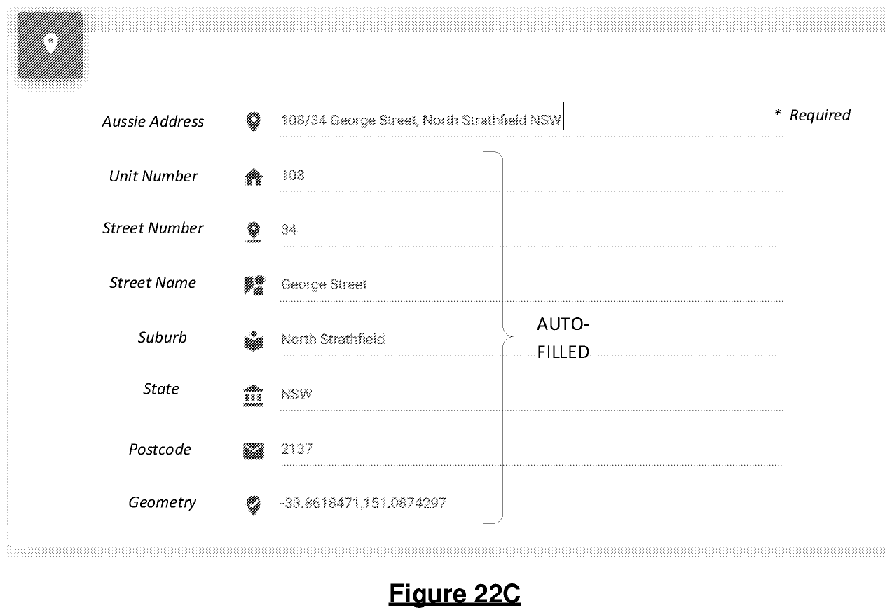

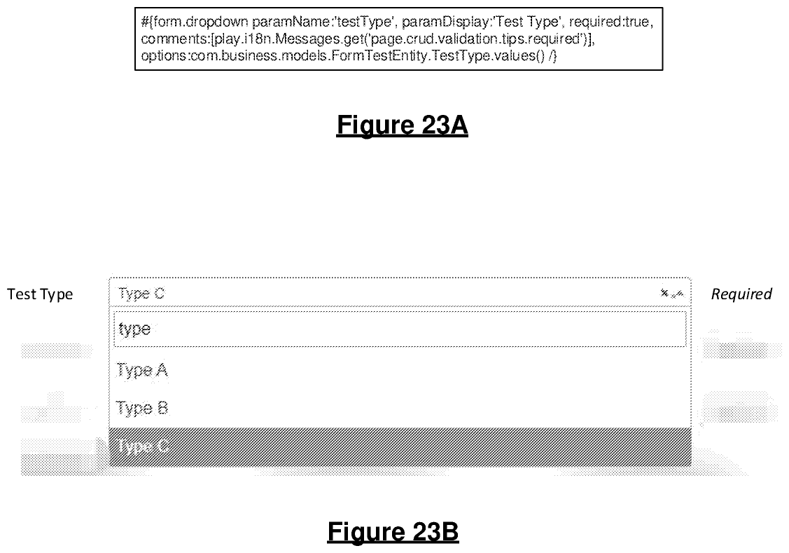

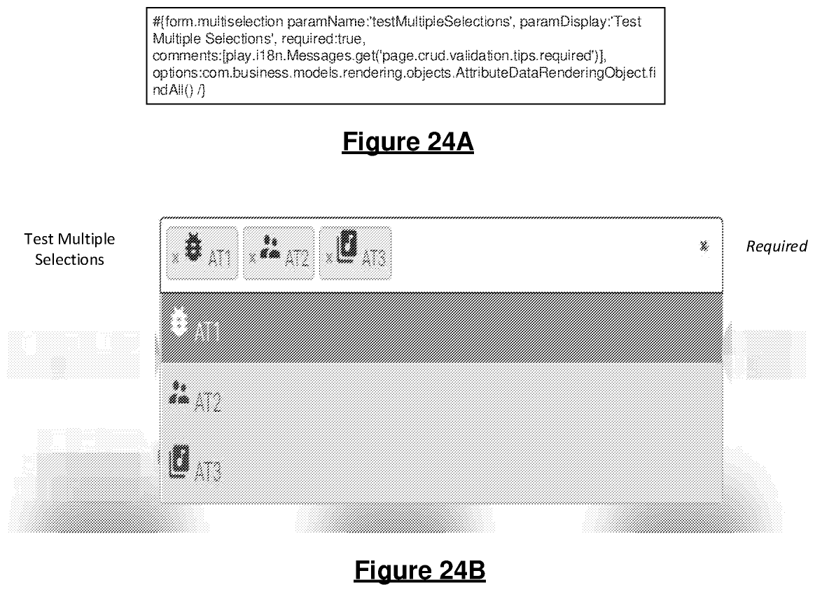

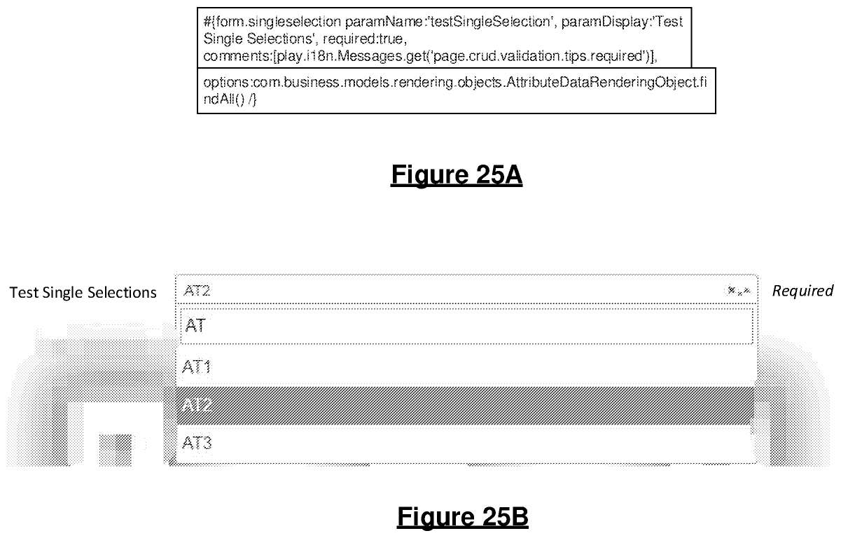

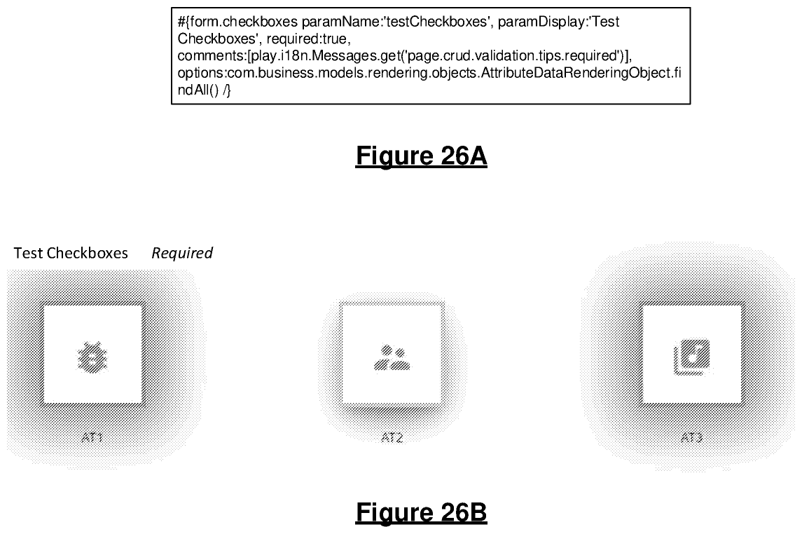

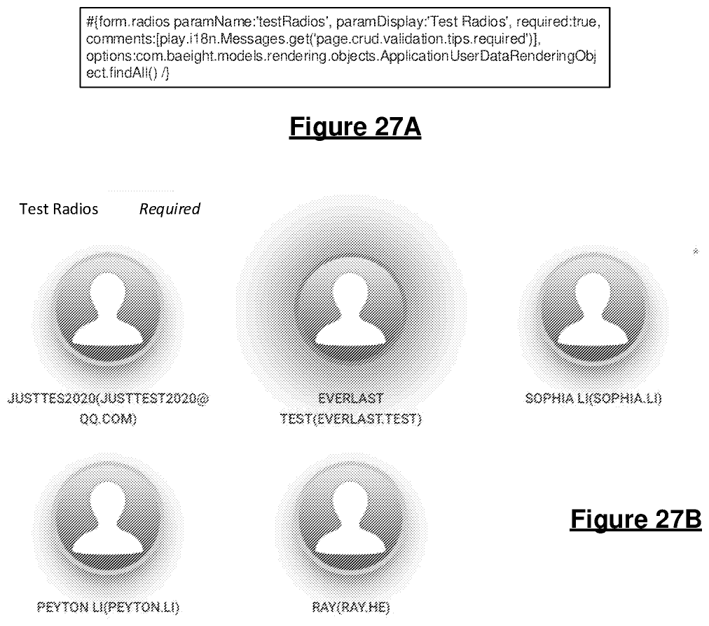

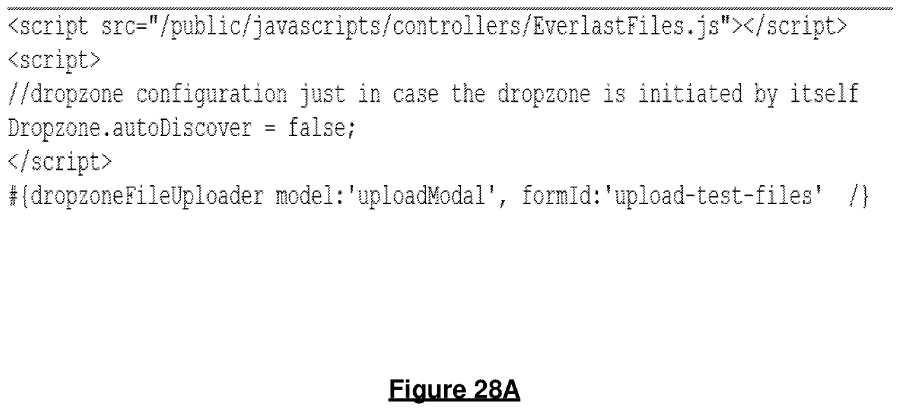

The CRUD input tags includes one or more of:
a text tag, an example of the command code shown in FIG. 12A to be transformed into standard HTML to render a text input in a HTML form, an example of which is shown in FIG. 12B, passing its value when submitting the form;
an email tag, an example of the command code shown in FIG. 13A to be transformed into standard HTML to render an email input with validation in a HTML form, an example of which is shown in FIG. 13B, passing its value when submitting the form;
a password tag, an example of the command code shown in FIG. 14A to be transformed into standard HTML to render a password input with validation in a HTML form, an example of which is shown in FIG. 14B, passing its value when submitting the form;
a number tag, an example of the command code shown in FIG. 15A to be transformed into standard HTML to render a number input in a HTML form (with validation on value ranged from 0 to 100, and incremental step 1), an example of which is shown in FIG. 15B, passing its value when submitting the form;
a uniform resource locator (URL) tag, an example of the command code shown in FIG. 16A to be transformed into standard HTML to render a uniform resource locator (URL) input with validation in a HTML form, an example of which is shown in FIG. 16B, passing its value when submitting the form;
a contact tag, an example of the command code shown in FIG. 17A to be transformed into standard HTML to render a telephone/mobile telephone number input with validation in a HTML form, an example of which is shown in FIG. 17B, passing its value when submitting the form;
one or more date tags, an example of the command code shown in FIG. 18A to be transformed into standard HTML to render a date picker input with validation in a HTML form, an example of which is shown in FIG. 18B, passing its value when submitting the form;
one or more time tags, an example of the command code shown in FIG. 19A to be transformed into standard HTML to render a time picker input with validation in a HTML form, an example of which is shown in FIG. 19B, passing its value when submitting the form;
a text area tag, an example of the command code shown in FIG. 20A to be transformed into standard HTML to render a text area input in a HTML form, an example of which is shown in FIG. 20B, passing its value when submitting the form;
a toggle button tag, an example of the command code shown in FIG. 21A to be transformed into standard HTML to render a toggle button input in a HTML form, an example of which is shown in FIG. 21B, passing its value when submitting the form;
an address tag, an example of the command code shown in FIG. 22A to be transformed into standard HTML to render an address input box with world-wide address suggestions, and a group an dress detail inputs (where all address details are automatically filled by Google Maps API), examples of which are shown in FIGS. 22B and 22C, passing its value when submitting the form;
a dropdown menu tag, an example of command code shown in FIG. 23A to be transformed into standard HTML to render a dropdown list input with given options as suggestions in a HTML form, an example of which is shown in FIG. 23B, passing its value when submitting the form;
a multiple selection dropdown menu tag, an example of command code shown in FIG. 24A to be transformed into standard HTML to render a dropdown list input with given options as suggestions in a HTML form (and it accepts multiple values), an example of which is shown in FIG. 24B, passing its value when submitting the form;
a single selection dropdown menu tag, an example of command code for a multiple selection dropdown list shown in FIG. 25A to be transformed into standard HTML to render a dropdown list input with given options as suggestions in a HTML form (and it only accepts one value), an example of which is shown in FIG. 25B, passing its value when submitting the form;
a checkbox tag, an example of command code shown in FIG. 26A to be transformed into standard HTML to render a list of given options as icons in a HTML form (and it accepts multiple values), an example of which is shown in FIG. 26B, passing its value when submitting the form;
a radios tag, an example of command code shown in FIG. 27A to be transformed into standard HTML to render a list of given radio button options as icons in a HTML form (and it only accepts one value), an example of which is shown in FIG. 27B, passing its value when submitting the form; and
a hidden input tag, an example of command code: “#{form.text paramName: ‘testHidden’/}”, to be transformed into standard HTML to create a hidden input HTML form and passing its value when submitting the form.

The use of various widgets within platform 100 will be looked at in more detail here. In embodiments of platform 100 in respect of widget implementation, input module 101 of platform 100 only receives client data in HTML for first module 111 and calls the data in Java within third module 113 to obtain a rendering object, then the render in JS defined in the second module 112 is called. It is noted that there is no specific input data required for second module 112. Second module 112 includes a plurality of pre-programmed code blocks of a second type and the second type of pre-programmed code blocks are in JavaScript. Further, first, second and third modules 111, 112 and 113 are operatively associated with each other such that, based on the inputted HTML and Java client data, framework module 102 automatically utilises one or more of the pre-programmed code blocks of the second type to generate the customised software product.

In embodiments of platform 100 in respect of widgets, the process flow follows the following main steps:
1) Request Dispatcher interface is accessed.
2) The Request Dispatcher opens widget demo page (HTML container for showing the particular widget) within first module 111.
3) JS data request calls the relevant render method in JS plugin within second module 112 (the JS controller, equivalent to the Everlast JS Controller).
4) A data request is sent to a server within third module 113 (the Java server controller, equivalent to the Everlast Data Controller server) to prepare the data to be shown, and transform the data to be shown to a data rendering object.
5) Render data as JSON back to second module 112.
6) Show the particular widget within the HTML page.

It will be appreciated that in other embodiments, steps 3) and 4) above are performed simultaneously. Further, in yet other embodiments, steps 3) and 4) above are performed in reverse order, that is, step 4) will be carried out prior to step 3).

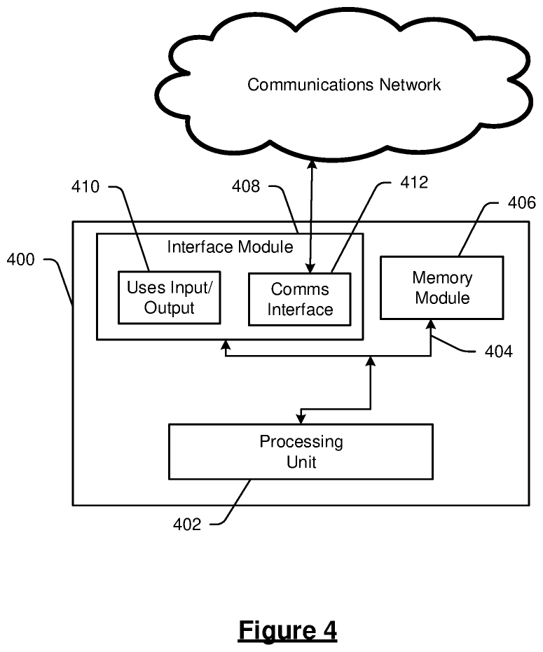

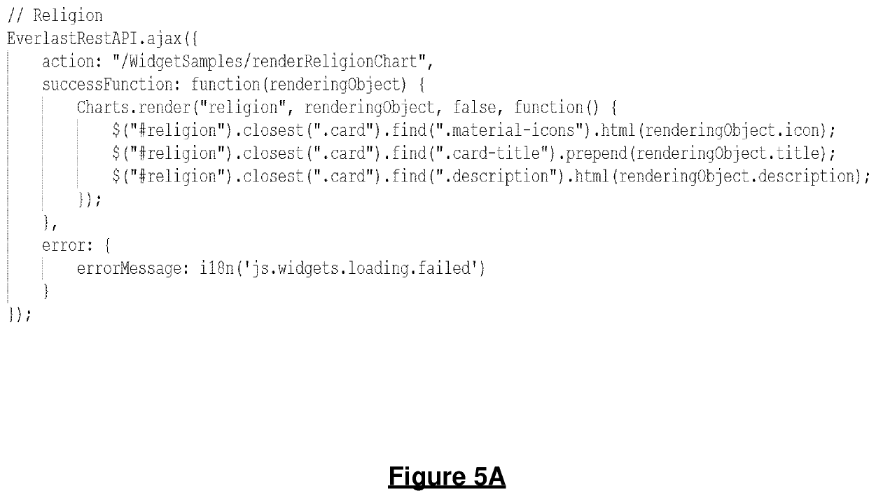

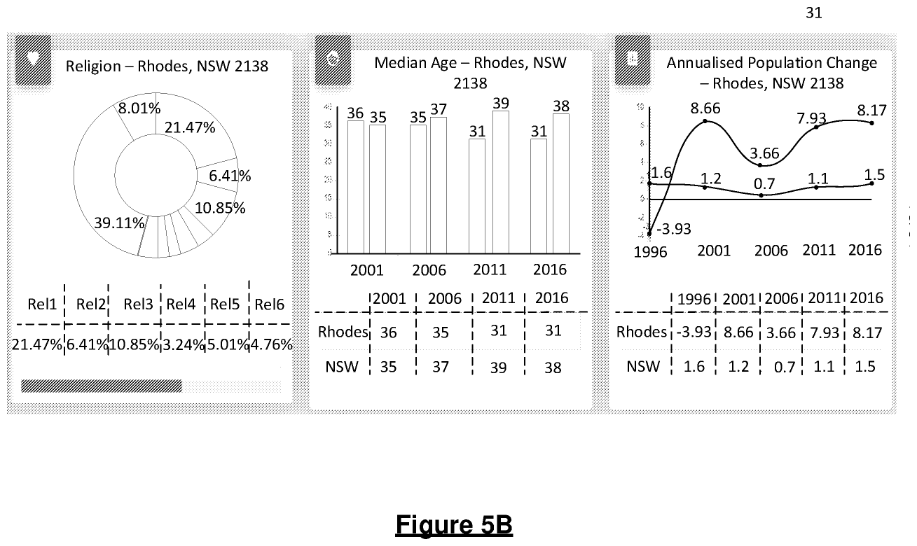

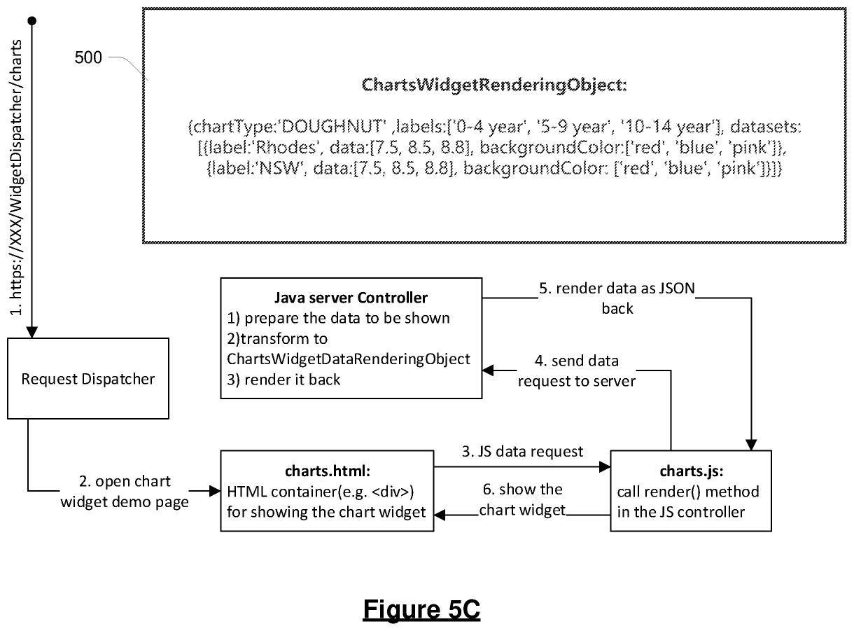

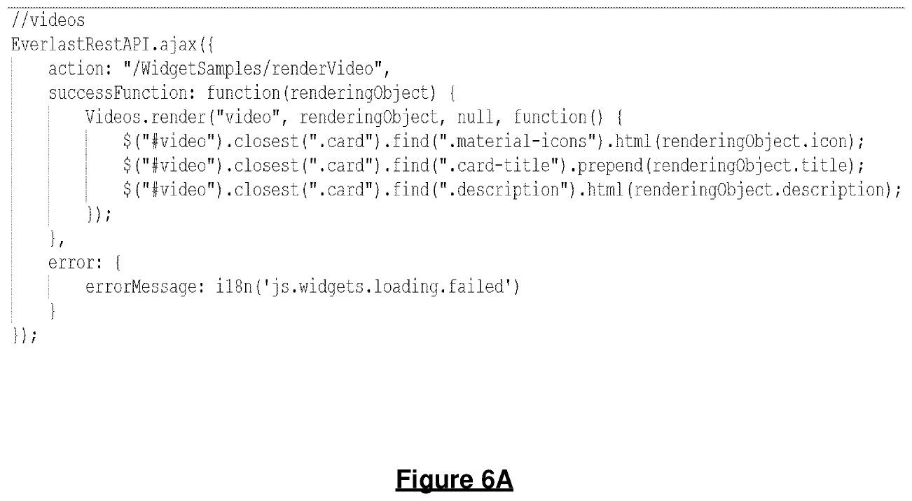

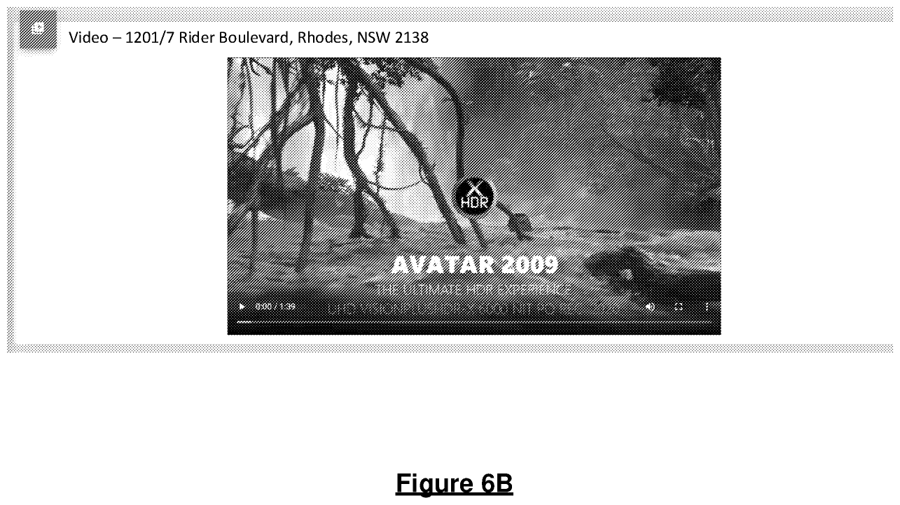

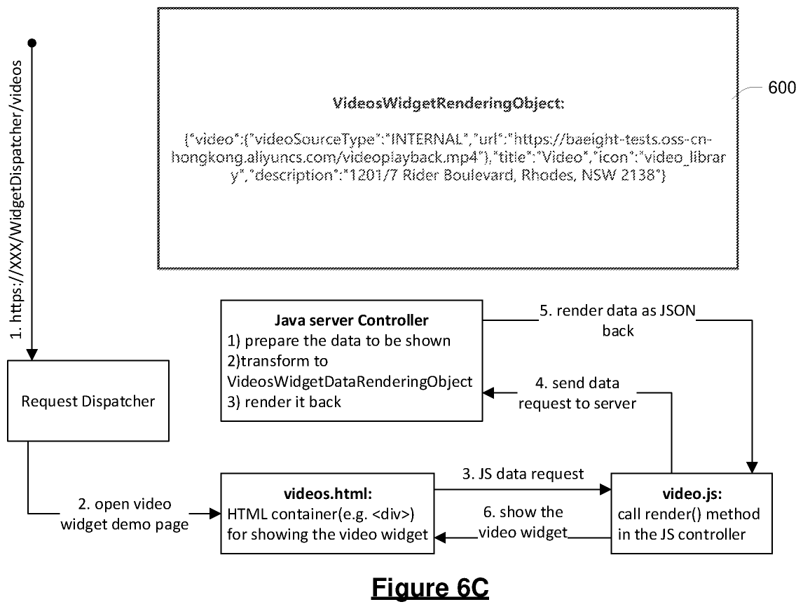

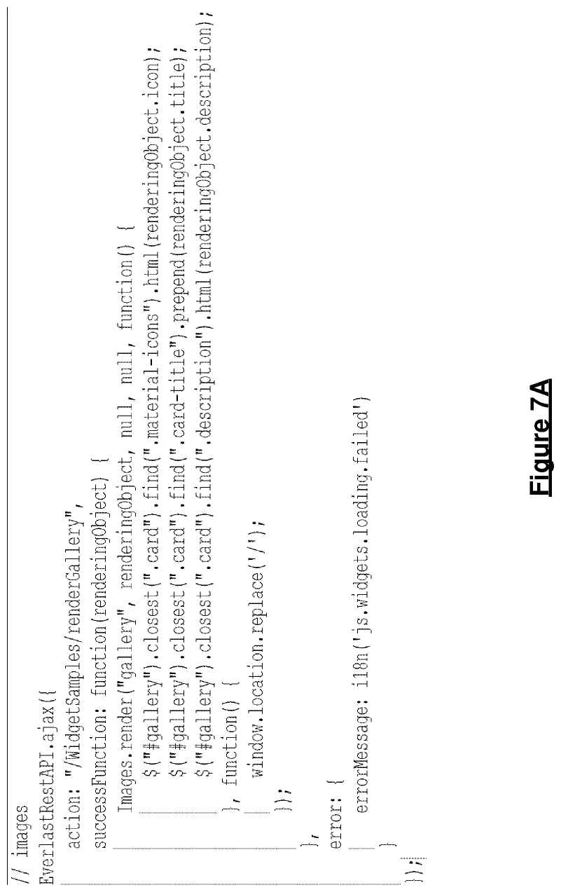

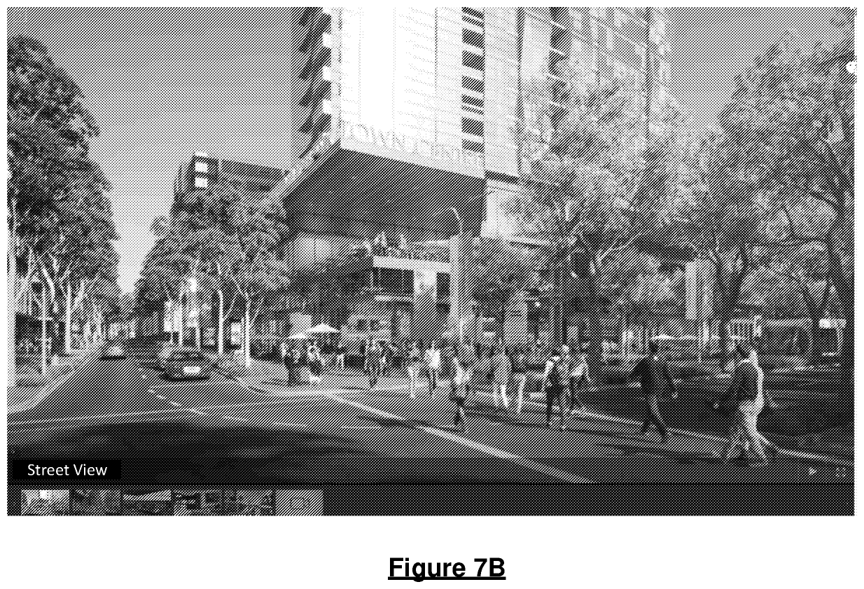

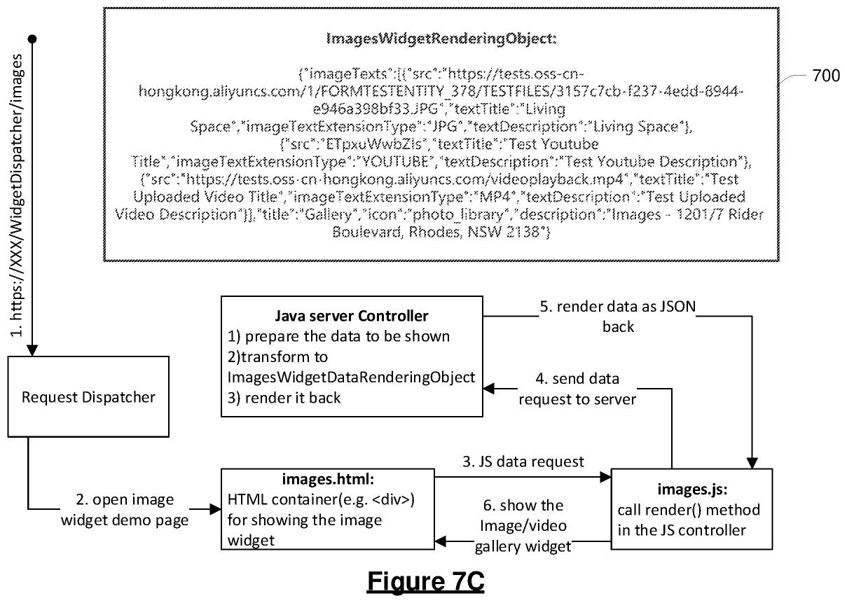

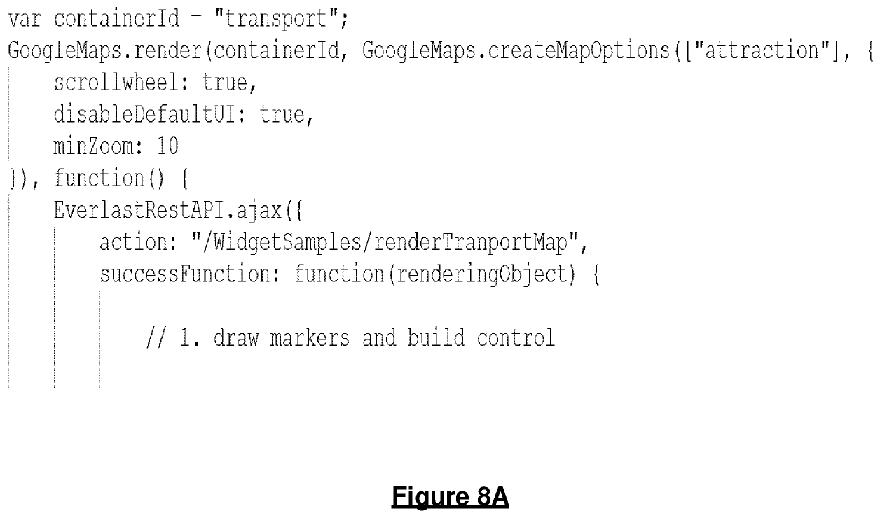

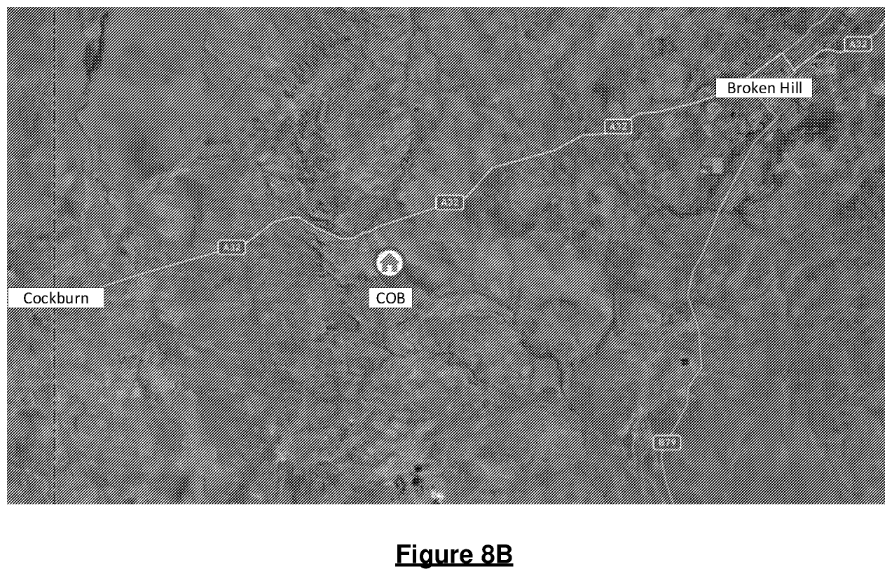

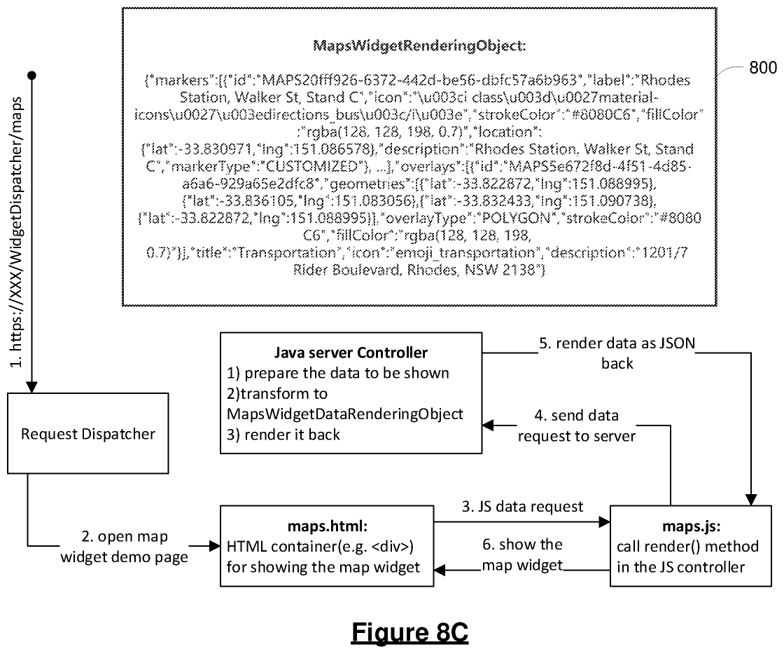

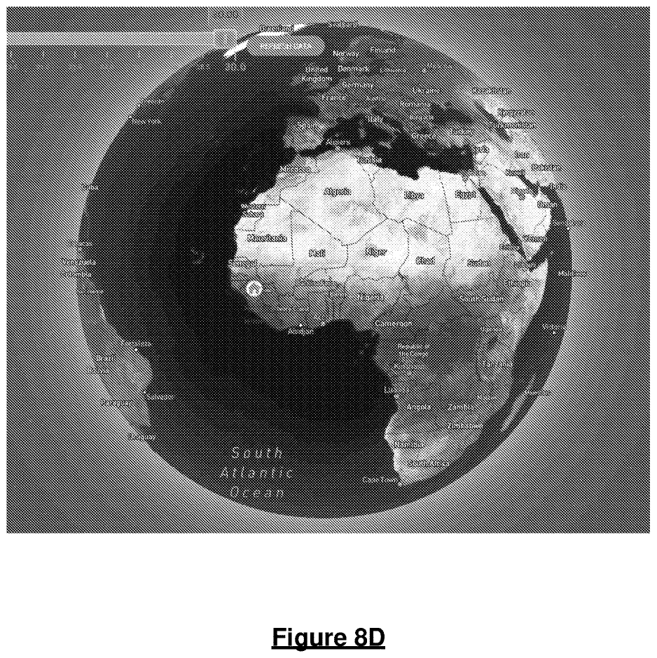

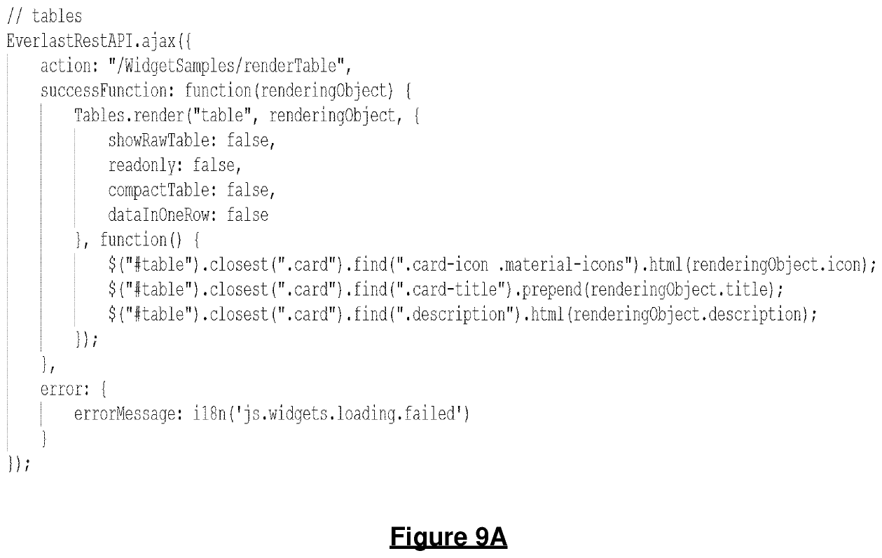

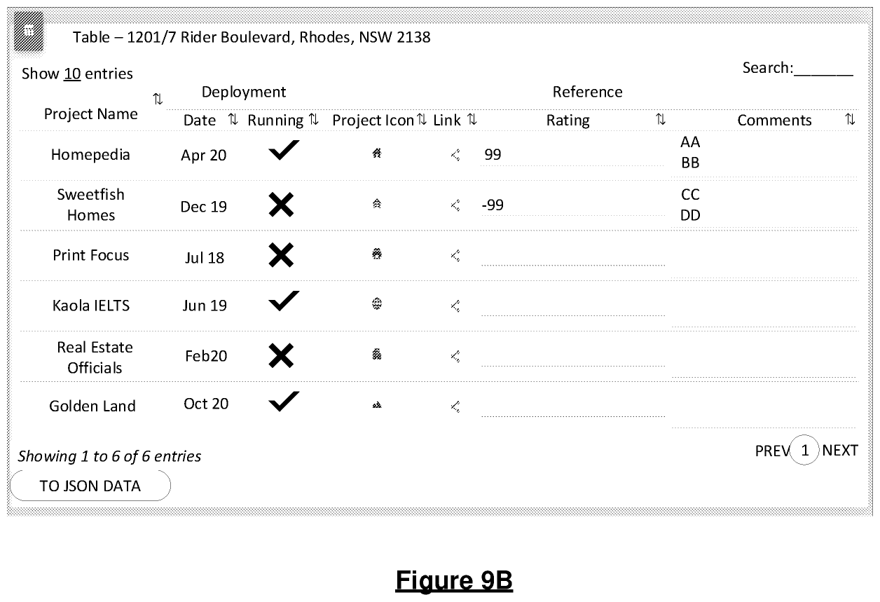

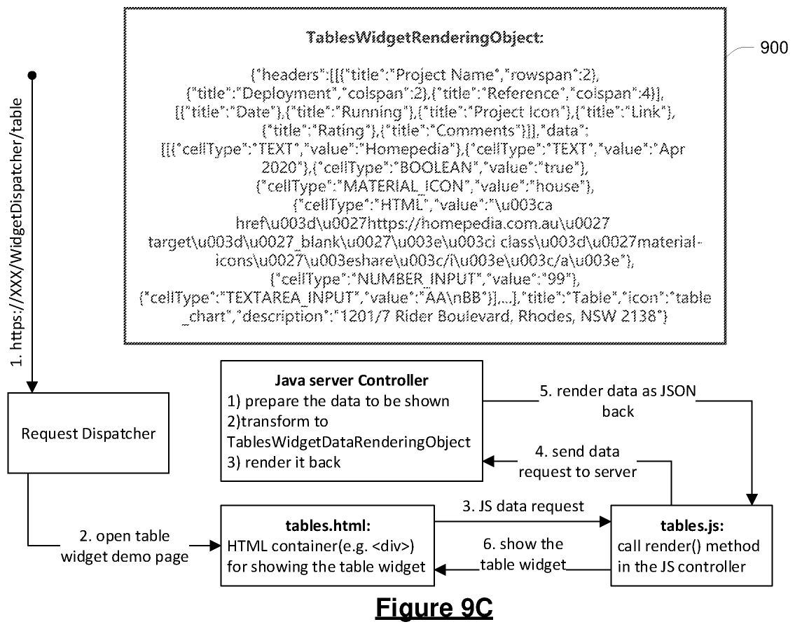

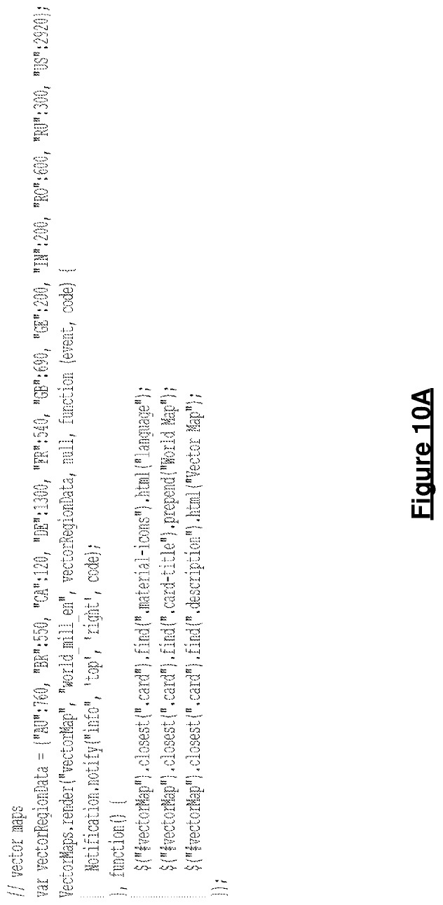

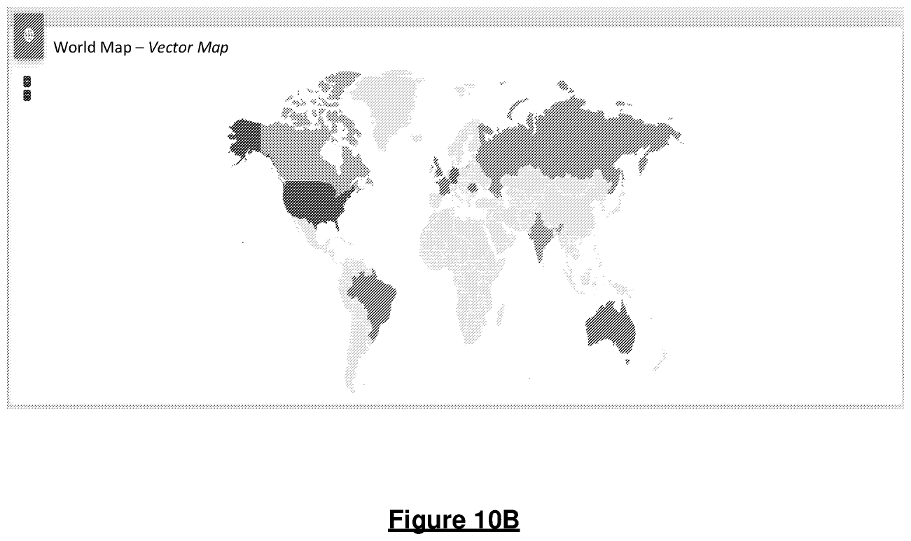

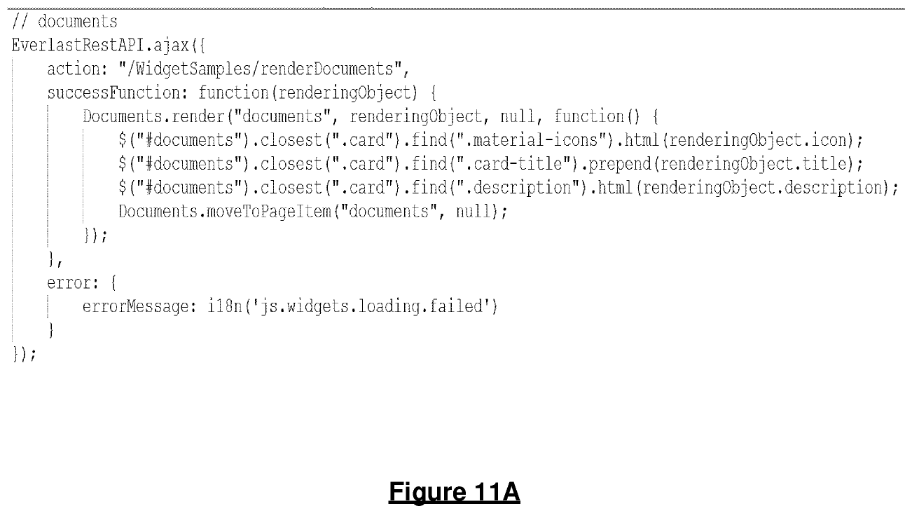

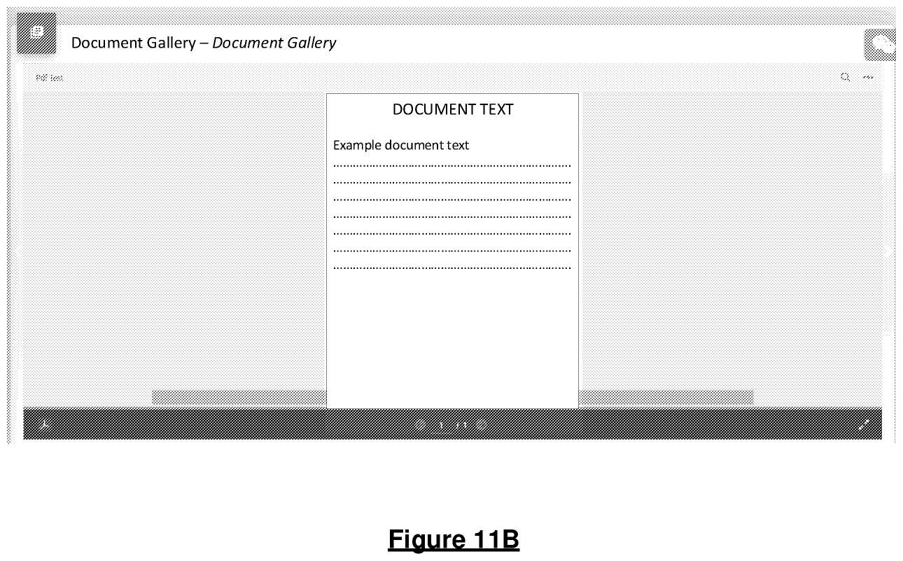

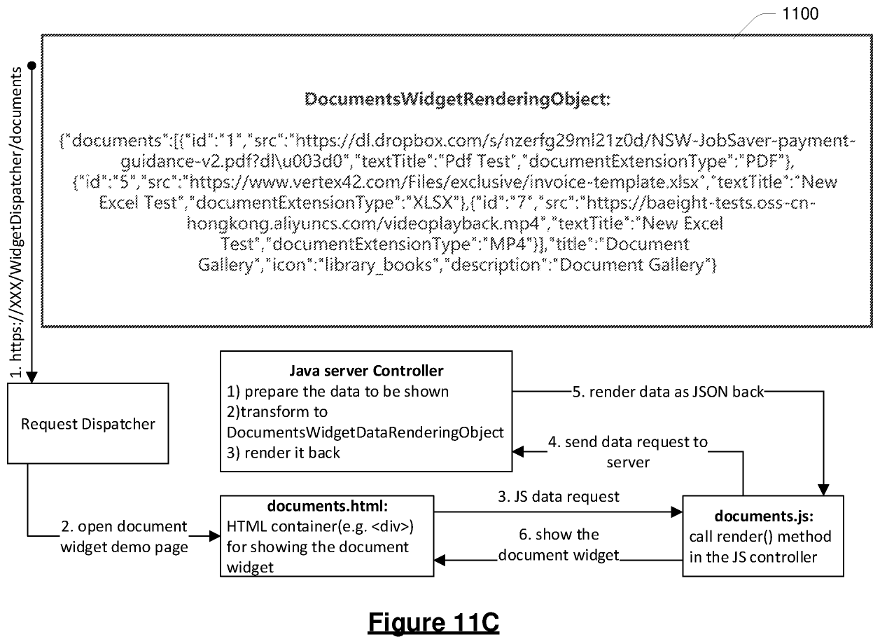

More specifically, the widget templates includes one or more of:
a chart widget, with an example of the client input data inputted into platform 100 shown in FIG. 5A and an example of a feature of the customised software products outputted from platform 100 shown in FIG. 5B. Creation of such a widget is initiated by an ajax call to get an object instance for the required data before calling a widget function to render the chart. Referring to FIG. 5C, there is illustrated an implementation of a process for use of platform 100 for implementing the chart widget of FIG. 5B through input module 101:
1. Request Dispatcher interface is accessed at “https://XXX/widgetDispatcher/charts”.
2. The Request Dispatcher opens a chart widget demo page “charts.html” (HTML container for showing the chart widget) within first module 111.
3. JS data request calls a render method of JS plugin “charts.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “ChartsWidgetDataRenderingObject” (where an example the of the Java code of ChartsWidgetDataRenderingObject inputted into input module 101 shown at 500).
5. Render data as JSON back to second module 112.
6. Show the chart widget within the charts.html page.
a document widget that supports multiple types of doucments, with an example of the client input data inputted into platform 100 shown in FIG. 11A and an example of a feature of the customised software products outputted from platform 100 shown in FIG. 11B. Creation of such a widget is initiated by an ajax call to get an object instance for the required data before calling a widget function to render the document reader. Referring to FIG. 11C, there is illustrated an implementation of a process for use of platform 100 for implementing the document widget of FIG. 11B through input module 101:
1. Request Dispatcher interface is accessed at “https://XXX/widgetDispatcher/documents”.
2. The Request Dispatcher opens a document widget demo page “documents.html” (HTML container for showing the document widget) within first module 111.
3. JS data request calls a render method of JS plugin “documents.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “DocumentsWidgetRenderingObject” (where an example the of the Java code of DocumentsWidgetRenderingObject inputted into input module 101 shown at 1100).
5. Render data as JSON back to second module 112.
6. Show the document widget within the documents.html page.
one or more image widgets in the form of an image gallery (also applicable to a video gallery) where multiple images can be browsed and zoomed in or out etc., with an example of the client input data inputted into platform 100 shown in FIG. 7A and an example of a feature of the customised software products outputted from platform 100 shown in FIG. 7B. Creation of such a widget is initiated by an ajax call to get an object instance for the required data before calling a widget function to render the image gallery. Referring to FIG. 7C, there is illustrated an implementation of a process for use of platform 100 for implementing the image widget of FIG. 7B through input module 101:
1. Request Dispatcher interface is accessed at “https://XXX/widgetDispatcher/images”.
2. The Request Dispatcher opens a image/gallery widget demo page “images.html” (HTML container for showing the image/gallery widget) within first module 111.
3. JS data request calls a render method of JS plugin “images.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “ImagesWidgetRenderingObject” (where an example the of the Java code of ImagesWidgetRenderingObject inputted into input module 101 shown at 700).
5. Render data as JSON back to second module 112.
6. Show the image/gallery widget within the images.html page.
one or more video widgets shown as an embedded video frame, with an example of the client input data inputted into platform 100 shown in FIG. 6A and an example of a feature of the customised software products outputted from platform 100 shown in FIG. 6B. Creation of such a widget is initiated by an ajax call to get an object instance for the required data before calling a widget function to render the video frame. Referring to FIG. 6C, there is illustrated an implementation of a process for use of platform 100 for implementing the video widget of FIG. 6B through input module 101:
1. Request Dispatcher interface is accessed at “https://XXX/widgetDispatcher/videos”.
2. The Request Dispatcher opens a video widget demo page “videos.html” (HTML container for showing the video widget) within first module 111.
3. JS data request calls a render method of JS plugin “videos.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “VideosWidgetRenderingObject” (where an example the of the Java code of VideosWidgetRenderingObject inputted into input module 101 shown at 600).
5. Render data as JSON back to second module 112.
6. Show the video widget within the videos.html page.
a map widget displaying an interactive map (for example from mapbox API or Google Maps API or) including but not limited to customized markers, overlays, information windows, themes, legend, and marker tables. The markers can be selected to, for example, open up a detailed view or watch map animation, amongst others. Further, the displayed map will allow for zooming in and out to show greater detail and greater area, respectively. Where a map zooms out to a certain predefined level, the map will automatically convert from a 2D flat map to a 3D globe map, as shown in FIG. 8D. It will be appreciated that the map itself will firstly be initialised (by calling the requisite JS widget template and then the Java data controller is called to render the markers and overlays (more on this below). An example of the client input data inputted into platform 100 is shown in FIG. 8A and an example of a feature of the customised software products outputted from platform 100 is shown in FIG. 8B. Creation of such a widget is initiated by an ajax call to get an object instance for the required data before calling a widget function to render the interactive map. Referring to FIG. 8C, there is illustrated an implementation of a process for use of platform 100 for implementing the map widget of FIG. 8B through input module 101:
1. Request Dispatcher interface is accessed at “https://XXX/widgetDispatcher/maps”.
2. The Request Dispatcher opens a map widget demo page “maps.html” (HTML container for showing the map widget) within first module 111.
3. JS data request calls a render method of JS plugin “maps.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “MapsWidgetRenderingObject” (where an example the of the Java code of MapsWidgetRenderingObject inputted into input module 101 shown at 800).
5. Render data as JSON back to second module 112.
6. Show the map widget within the maps.html page.
a table widget displaying data in a sortable and searchable table with the cells of the table including but not limited to text, numbers, icons, links and other inputs. An example of the client input data inputted into platform 100 is shown in FIG. 9A and an example of a feature of the customised software products outputted from platform 100 is shown in FIG. 9B. Creation of such a widget is initiated by an ajax call to get an object instance for the required data before calling a widget function to render the data table. Referring to FIG. 9C, there is illustrated an implementation of a process for use of platform 100 for implementing the table widget of FIG. 9B through input module 101:
1. Request Dispatcher interface is accessed at “https://XXX/widgetDispatcher/tables”.
2. The Request Dispatcher opens a table widget demo page “tables.html” (HTML container for showing the table widget) within first module 111.
3. JS data request calls a render method of JS plugin “tables.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “TablesWidgetRenderingObject” (where an example the of the Java code of TablesWidgetRenderingObject inputted into input module 101 shown at 900).
5. Render data as JSON back to second module 112.
6. Show the table widget within the tables.html page.
a vector map widget, with an example of the client input data inputted into platform 100 shown in FIG. 10A and an example of a feature of the customised software products outputted from platform 100 shown in FIG. 10B. Creation of such a widget is initiated by an ajax call to get an object instance for the required data before calling a widget function to render the vector map. It will be appreciated that the implementation process for use of platform 100 for implementing the vector map widget of FIG. 10B through input module 101 will mirror the steps of the above implementation processes for the other widget examples of FIGS. 5C, 6C, 7C, 8C, 9C and 11C.

In preferred embodiments, the one or more image widgets, the one or more video widgets are combined into a single multimedia widget where media files including photos and videos in various file formats are able to be displayed in a same gallery (similar in layout to the image widget of FIG. 7B). Similar to the widgets above, creation of such a widget is initiated by an ajax call to get an object instance for the required data before calling a widget function to render the multimedia gallery. An implementation of a process for use of platform 100 for implementing the multimedia widget through input module 101 is as follows:
1. Request Dispatcher interface is accessed at “https://XXX/widgetDispatcher/multimedia”.
2. The Request Dispatcher opens a multimedia widget demo page “multimedia.html” (HTML container for showing the multimedia widget) within first module 111.
3. JS data request calls a render method of JS plugin “multimedia.js” within second module 112 (the JS controller, equivalent to the Everlast JS Controller).
4. A data request is sent to a server within third module 113 (the Java server controller, equivalent to the Everlast Data Controller server) to prepare the data to be shown, and transform the data to be shown to a data rendering object “ImagesWidgetRenderingObject” (where an example the of the Java code of ImagesWidgetRenderingObject inputted into input module 101 shown at 700).
5. Render data as JSON back to second module 112.
6. Show the multimedia widget within the multimedia.html page.

In yet further embodiments, the multimedia widget also includes the document widget.

It will be appreciated that for each of the above implementation processes for the other widget examples of FIGS. 5C, 6C, 7C, 8C, 9C and 11C, in other embodiments, steps 3) and 4) are performed simultaneously. Further, in yet other embodiments, steps 3) and 4) above are performed in reverse order, that is, step 4) will be carried out prior to step 3).

Implementation of the above widgets will be looked at in more detail, in particular comparing the implementation of the various models in existing processes compared to the implementation in the process using platform 100.

For implementing the charts widget illustrated in FIG. 5B, an existing known implementation process requires the following steps:
Import chart plugin, for example chart.js;
Study the API document of the plugin;
Construct the data structure and render JSON to be the input to the plugin, that is, construct relevant input based on API requirements; and
Adjust the CSS and HTML layout to display a chart on the page, that is, so it fits on a page.

The implementation process of platform 100 simply requires parameters to be provided and the API used as illustrated in FIGS. 5A and 5C.

For implementing the video widget illustrated in FIG. 6B, an existing known implementation process requires the following steps:
Write the HTML for showing the video, for example <video> or <iframe>; and
Adjust the CSS and HTML layout to display.

The implementation process of platform 100 simply requires parameters to be provided and the API used as illustrated in FIGS. 6A and 6C.

For implementing the image/video gallery widget illustrated in FIG. 7B, an existing known implementation process requires the following steps:
Import gallery plugin, for example unitegallery.js;
Study the API document of the plugin;
Construct the data structure and render JSON to be the input to the plugin; and
Adjust the CSS and HTML layout to display the gallery on a page.

The implementation process of platform 100 simply requires parameters to be provided and the API used as illustrated in FIGS. 7A and 7C.

For implementing the map widget illustrated in FIGS. 8B and 8D, an existing known implementation process requires the following steps:
Import map plugin, for example mapbox maps API;
Study the API document of the plugin;
Construct the data structure and render JSON to be the input to the plugin; and
Adjust the CSS and HTML layout to display the map on a page.

The implementation process of platform 100 simply requires parameters to be provided and the API used as illustrated in FIGS. 8A and 8C.

For implementing tables widget illustrated in FIG. 9B, an existing known implementation process requires the following steps:
Import data table plugin, for example datatable.js;
Study the API document of the plugin;
Construct the data structure and render JSON to be the input to the plugin; and
Adjust the CSS and HTML layout to display the data table on a page.

The implementation process of platform 100 simply requires parameters to be provided and the API used as illustrated in FIGS. 9A and 9C.

For implementing the vector maps widget illustrated in FIG. 10B, an existing known implementation process requires the following steps:
Import vector map plugin, for example vectormaps.js;
Study the API document of the plugin;
Construct the data structure and render JSON to be the input to the plugin; and
Adjust the CSS and HTML layout to display the vector map on a page.

The implementation process of platform 100 simply requires parameters to be provided and the API used as illustrated in FIG. 10A.

For implementing the document widget illustrated in FIG. 11B, an existing known implementation process requires the following steps:
Import gallery viewer plugin, for example carousel.js;
Study the API document of the plugin;
Construct the data structure and render JSON to be the input to the plugin; and
Adjust the CSS and HTML layout to display the document/multimedia viewer on a page.

The implementation process of platform 100 simply requires parameters to be provided and the API used as illustrated in FIGS. 11A and 11C.

It will be appreciated that platform 100 extends the page design and styles templates of Material Dashboard Pro. This extension involves modifying the templates, for example, changing the theme colour of the pages according to different projects and users. In alternate embodiments, with alternate embodiments platform 100 extends the page design and styles templates based on other templates, for example, Paper Dashboard, SoftUI Dashboard, and others, although additional developmental step are required to utilise templates other than those based on Material Dashboard Pro.

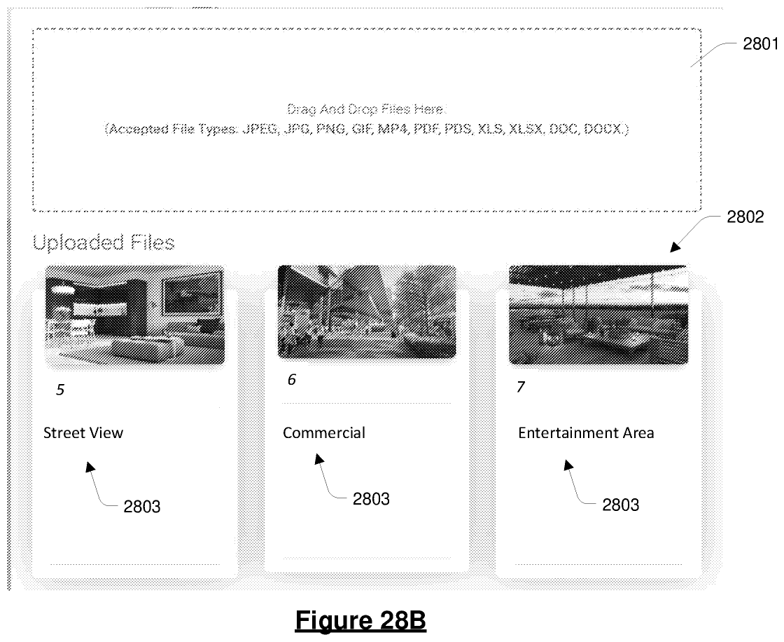

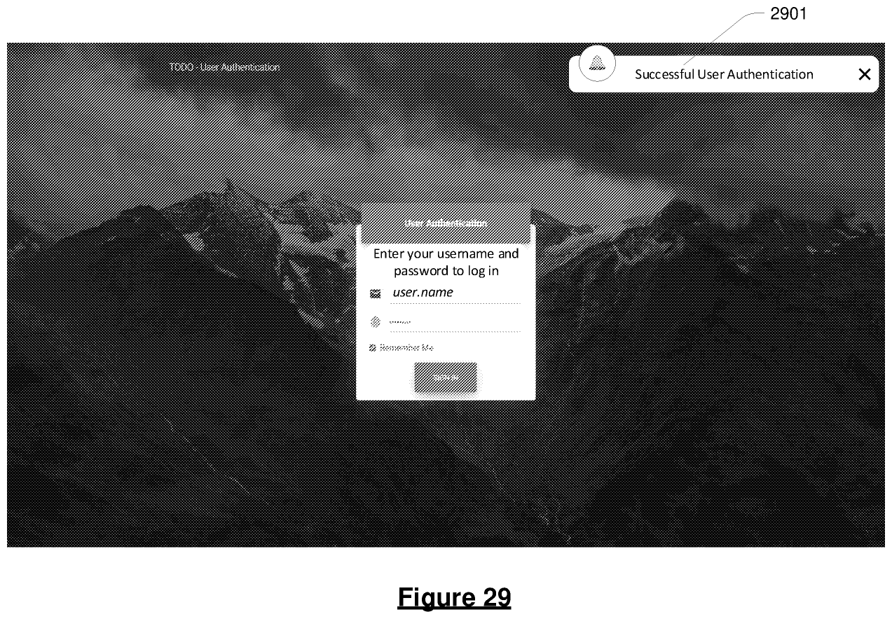

The file uploader view module will utilise a third party plugin to include a feature of a dropzone file uploader, for example, DropzoneJS file uploader. Such a file uploader is introduced by calling the requisite pre-programmed code block of the second type, in this case “EverlastFiles.js” plugin, from the inputted client data and specifying the parameters of the file uploader, for example, the code shown in FIG. 28A (where the DropzoneJS autoDiscover setting “Dropzone.autoDiscover” is set to “false” to prevent automatic initiation, then the tag “dropzoneFileUploader” is added and the parameters are specified).

Referring to FIG. 28B, the file uploader allows “drag and drop” of various file types (for example, JPEG, JPG, PNG, GIF, MP4, PDF, PDS, XLS, XLSX, DOC, DOCX) to a rendered area shown as a box defined by a broken line 2801 after which they are uploaded (which includes the JS data controller, second module 112, processing and validating the uploaded document) and stored by the server (which includes the Java data controller, third module 113, being called to store the uploaded document in cloud storage). For each upload which may include multiple files, once dropped files are successfully uploaded, the previewed files will appear in an “uploaded files” section 2802, and users can comment each of the files in a text area 2803 below each previewed file.

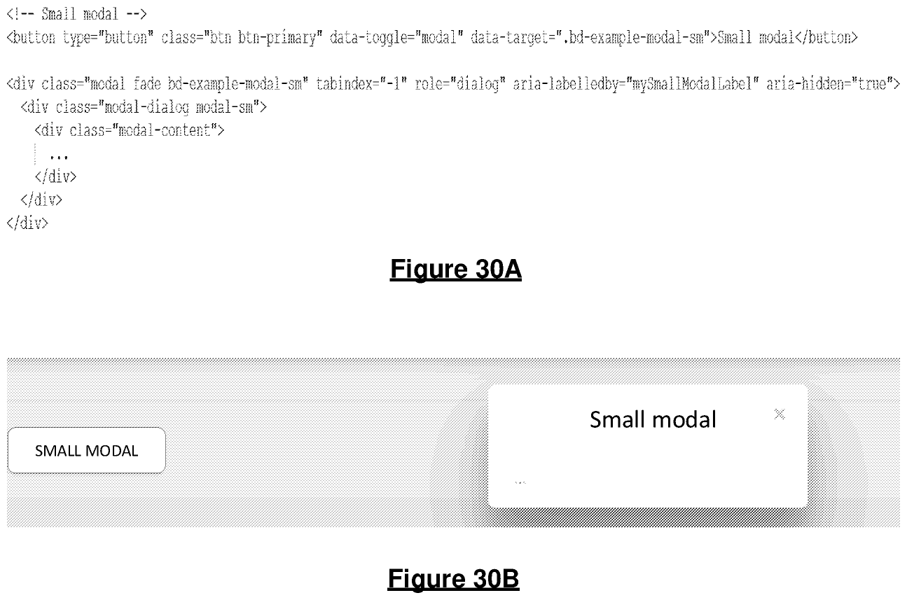

The system notification view module will also utilise a third party plugin, for example Bootstrap Notify, where a popup notification is to be displayed as a feature of the customised software product. The parameters of this module, in one embodiment, include style of the message (from a plurality of predetermined styles), a position of the notification, alignment of the notification, and the actual notification message (which are called, for example, through command “Notification.notify (style, from, align, message)”). An example of a rendered system notification is shown in FIG. 29 and denoted by reference 2901, where the above parameters are as follows: “success”, “top”, “right”, “Successful User Authentication”. In another embodiments, the parameters include a position of the notification, alignment of the notification, a delay time in displaying the notification and the notification message in HTML form (which are called, for example, through command “Notification.notifyWithHTML (from, align, delay, html)”).

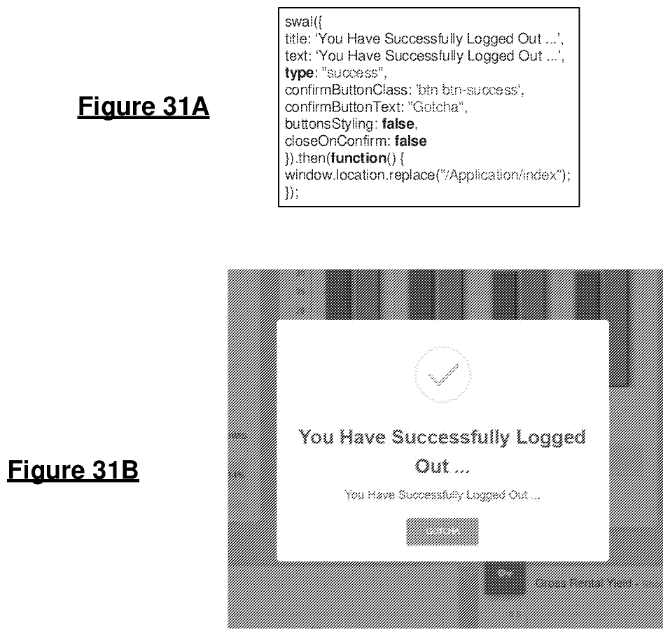

Referring to FIGS. 30A and 30B, implementing the system modal window feature will also utilise a third party plugin to include a feature of a modal window, for example Bootstrap, where a modal window is implemented by setting for a specific controller element, such as a displayed button, a specific modal to toggle. Such a system modal window is introduced from inputted client data, for example the code shown in FIG. 30A which renders the modal window shown in FIG. 30B.

The alert prompts will also utilise a third party plugin to include a feature of an alert popup, for example Sweet Alert 2 which calls the “swal” method to show an alert prompt popup. Referring to the example of FIGS. 31A and 31B, the client input data inputted into platform 100 shown in FIG. 31A and an example of the alert prompt popup outputted from platform 100 shown in FIG. 31B.

For each of the notification, modal and alert features above, platform 100 is unique in the way it calls each respective API as it includes default parameters as part of its unique API call. For example, each of the notification, modal and alert features traditionally requires one or more parameters to manually define the position of the notification, modal or alert popup. The API call of platform 100 will include default parameters to define the position, such as centering the popup.

FIG. 4 provides a block diagram of a computer processing system 400 configurable to perform various functions described herein, for example the functions of platform 100. System 400 is a general purpose computer processing system. It will be appreciated that FIG. 4 does not illustrate all functional or physical components of a computer processing system. For example, no power supply or power supply interface has been depicted. However, system 400 will either carry a power supply or be configured for connection to a power supply (or both). It will also be appreciated that the particular type of computer processing system will determine the appropriate hardware and architecture, and in some embodiments alternative computer processing systems suitable for implementing features of the present disclosure will have additional, alternative, or fewer components than those depicted.

Computer processing system 400 includes at least one processing unit 402. In some embodiments, processing unit 402 is a single computer processing device (for example, a central processing unit, graphics processing unit, or other computational device). In other embodiments, processing unit 402 includes a plurality of computer processing devices. In some embodiments, where system 400 is described as performing an operation or function, all processing required to perform that operation or function will be performed by processing unit 402. In other embodiments, processing required to perform that operation or function is also performed by remote processing devices accessible to and useable by (either in a shared or dedicated manner) system 400.

Through a communications bus 404, processing unit 402 is in data communication with a memory module 406 in the form of one or more machine readable storage (memory) devices which store instructions and/or data for controlling operation of system 400. In various embodiments, system 400 includes one or more of: a system memory (for example, resident set-size memory), volatile memory (for example, random access memory), and non-volatile or non-transitory memory (for example, one or more hard disk or solid-state drives). Such memory devices may also be referred to as computer readable storage media.

System 400 also includes one or more interfaces denoted by interface module 408, via which system 400 interfaces with various devices and/or networks. Generally speaking, in various embodiments, other devices are integral with system 400, or are separate. Where a device is separate from system 400, connection between the device and system 400, in various embodiments, is via wired or wireless hardware and communication protocols, and are a direct or an indirect (for example, networked) connection.

Wired connection with other devices/networks is facilitated by any appropriate standard or proprietary hardware and connectivity protocols. For example, in various embodiments, system 400 is be configured for wired connection with other devices/communications networks by one or more of: USB; FireWire; Ethernet; HDMI; and other wired connection interfaces.

Wireless connection with other devices/networks is similarly facilitated by any appropriate standard or proprietary hardware and communications protocols. For example, in various embodiments, system 400 is configured for wireless connection with other devices/communications networks using one or more of: infrared; Bluetooth; Wi-Fi; near field communications (NFC); Global System for Mobile Communications (GSM); Enhanced Data GSM Environment (EDGE); long term evolution (LTE); and other wireless connection protocols.

Generally speaking, and depending on the particular system in question, devices to which system 400 connects (whether by wired or wireless means) include one or more input devices to allow data to be input into/received by system 400 for processing by processing unit 402, and one or more output device to allow data to be output by system 400. A number of example devices are described below. However, it will be appreciated that, in various embodiments, not all computer processing systems will include all mentioned devices, and that additional and alternative devices to those mentioned are used.

Referring to reference 410, in one embodiment, system 400 includes or connects to one or more input devices by which information/data is input into (received by) system 400. Such input devices include keyboards, mice, trackpads, microphones, accelerometers, proximity sensors, GPS devices and the like. System 400, in various embodiments, further includes or connects to one or more output devices controlled by system 400 to output information. Such output devices include devices such as a cathode ray tube (CRT) displays, liquid-crystal displays (LCDs), light-emitting diode (LED) displays, plasma displays, touch screen displays, speakers, vibration modules, LEDs/other lights, amongst others. In embodiments, system 400 includes or connects to devices which are able to act as both input and output devices, for example memory devices (hard drives, solid state drives, disk drives, compact flash cards, SD cards and the like) which system 400 can read data from and/or write data to, and touch screen displays which can both display (output) data and receive touch signals (input).

System 400 also includes one or more communications interfaces 412 for communication with a network. Via the communications interface(s) 412, system 400 can communicate data to and receive data from networked devices, which in some embodiments are themselves other computer processing systems.

System 400 stores or has access to computer applications (also referred to as software, applications or programs), such as applications that provide the functionality of platform 100. These are also described as computer readable instructions and data which, when executed by the processing unit 402, configure system 400 to receive, process, and output data. Instructions and data are able to be stored on non-transient machine readable medium accessible to system 400. For example, in an embodiment, instructions and data are stored on non-transient memory 410. Instructions and data are able to be transmitted to/received by system 400 via a data signal in a transmission channel enabled (for example) by a wired or wireless network connection over interface such as 408.

Applications accessible to system 400 typically includes an operating system application such as Windows, macOS, IOS, Android, Unix, Linux, or other operating system.

In embodiments, applications that provide the functionality of platform 100 are dedicated applications that communicate with a server using an application programming interface (API). Alternatively, in other embodiments, the applications are a web browser (such as Chrome, Safari, Internet Explorer, Firefox, or an alternative web browser) which communicates with a web server using http/https protocols.

Furthermore, while a single computer processing system 400 has been depicted, in other embodiments, system 400 consists of multiple subsystems (for example, one or more web servers and/or one or more application servers).

It will be appreciated that users may access platform 100 on a server through a client portal. Thus, in terms of architecture, the communications and interactions generally reflect a client/server relationship whereby there is a client-side user device and a server-side device (both of which could take various forms of system 400).

When executed by the client-side user device (for example, by a processing unit such as 402), a client application configures the client-side user device to provide client-side functionality. This involves communicating (by way of a secure communication channel) with the server-side device. In embodiments, the client application is a dedicated application client that communicates with the server-side device using an application programming interface (API). Alternatively, in other embodiments, the client application is a web browser (such as Chrome, Safari, Internet Explorer, Firefox, or an alternative web browser) which communicates with a web server of the server-side device (or the server-side device itself being a web server) using http/https protocols over secure the communication channel.

In embodiments where the client application is a web browser, the server-side device includes a web server (for interacting with the web browser clients). Otherwise, the server-side device includes an application server (such as a network available applications service including a service providing API using web protocols, for example, http/https or gRPC) for interacting with dedicated application clients by way of the client application.

It will be appreciated that the single server-side device is configured to service multiple client-side user devices. It will be further appreciated that the server-side device consists of multiple servers (for example, one or more web servers and/or one or more application servers).

### Advantages of Detailed Embodiments

It will be appreciated that the embodiments of platform 100 described herein are advantageous over known systems as it provides efficient software development tools over known system. More specifically, platform 100 achieves the following advantages:
Provides an efficient framework for developing new customised software products.
The use of model, view, material template and security pre-programmed modules in particular provides more data efficient processing of developed customised software products.
The use of the pre-programmed modules provides variety of features as well as ease of customisation and configuration to the user.
Years of refinement of platform 100 by the inventor provides stability and reliability of functioning of developed customised software products.
Unique use of known third party plugins in new to provide new product features (for example, platform 100 uses chart.js in a unique way unlike existing system to create customized styles to make the chart 3D).
Builds on known MVC structures including structures used in Play! Framework whilst providing further pre-programmed modules and the improved technical functions and efficiencies noted above.
The use of the Model, Security and View modules facilitate efficient implementation of functions such as creating/deleting/updating data entries in any format, uploading documents, creating maps with markers and polygon overlays, and displaying data tables with searching and sorting functions, amongst other practical features.
Provides efficiencies in relation to development, testing and integration.
Intuitive and unique structure of platform 100 to facilitate ease of use.
Highly customisable to develop many different types of bespoke IT projects, including big data, web apps, mobile apps, amongst many others.

As such, platform 100 provides an efficient and robust tool developing a variety of types of customised software products including a variety of customisable features. Thus, the efficiency in terms of data processing, and the variety of types of customisable software products is advantageous over known systems through the use of the present platform.

### Conclusions and Interpretation

Throughout this specification, where used, the terms “element” and “component” are intended to mean either a single unitary component or a collection of components that combine to perform a specific function or purpose.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Unless specifically stated otherwise, as apparent from the following discussions, it is appreciated that throughout the specification discussions utilizing terms such as “processing,” “computing,” “calculating,” “determining”, analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, for example, from registers and/or memory to transform that electronic data into other electronic data that, for example, may be stored in registers and/or memory. A “computer” or a “computing machine” or a “computing platform” may include one or more processors.

Some methodologies or portions of methodologies described herein are, in one embodiment, performable by one or more processors that accept computer-readable (also called machine-readable) code containing a set of instructions that when executed by one or more of the processors carry out at least one of the methods described herein. A memory subsystem of a processing system includes a computer-readable carrier medium that carries computer-readable code (for example, software) including a set of instructions to cause performing, when executed by one or more processors, one of more of the methods described herein. Note that when the method includes several elements, for example, several steps, no ordering of such elements is implied, unless specifically stated. The software may reside in the storage medium, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, unless otherwise specified, the one or more processors operate as a standalone device or may be connected, for example, networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while only a single processor and a single memory that carries the computer-readable code may be shown herein, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein, unless otherwise specified.

Thus, one embodiment of each of the methods described herein is in the form of a computer-readable carrier medium carrying a set of instructions, for example, a computer program that is for execution on one or more processors, for example, one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, for example, a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (for example, a computer program product on a computer-readable storage medium) carrying computer-readable program code embodied in the medium.

The software may further be transmitted or received over a network via a network interface device. While the carrier medium may be shown in an embodiment to be a single medium, the term “carrier medium” should be taken to include a single medium or multiple media (for example, a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage.

### INDUSTRIAL APPLICABILITY

The arrangements described are applicable to many industries that utilise commercial IT systems and, and particularly to the updating of IT systems that require migration of data between an existing type of database to a new type of database that may not be compatible with the existing type of database. Therefore, the invention is clearly industrially applicable.

1. A software development platform for creating a customised software product in the form of a persistent storage application associated with a relational database, the platform including:
an input module for facilitating input of client data in at least a first programming language;
a framework module including:
a first programming language module for receiving the inputted client data;
a second controller module including data in a second programming language, the second module including a plurality of pre-programmed code blocks of a second type; and
a third centralised data controller module including data in a third programming language, the third module including a plurality of pre-programmed code blocks of a third type, wherein the first, second and third modules are operatively associated with each other such that, based on the inputted client data, the framework module automatically utilises one or more of the pre-programmed code blocks of the second type and one or more of the pre-programmed code blocks of the third type to generate the customised software product; and
an output module for outputting the customised software product, wherein the third centralised data controller module utilizes a plurality of data rendering objects to map: a third programming language entity to the relational database and subsequently maps to the third programming language entity a third programming language data rendering object, and the second controller module calls from the third module the third programming language data rendering object to be rendered in a text-based data format for forming at least part of the outputted customised software product,
further wherein the third centralised data controller module is configured to read one or more annotation instructions to automatically carry out one or more “create, read, update, and delete” (CRUD) operation,
further wherein the platform provides within the third module at least the following distinct framework annotations to define an entity:
an entity annotation including one or more of: a rendering entity attribute; an entity document attachment path prefix attribute; an entity file type attribute; an entity validation method attribute; an entity display name attribute; and an entity description attribute;
a CRUD list behavior annotation including one or more of: a list column order attribute; a list ascending or descending order attribute; and a list columns attribute; and
a CRID list column annotation including one or more of: a parameter name attribute; a column heading attribute; and a filter field attribute, and
wherein the third centralised data controller module is separate from a page dispatcher.

2. The software development platform according to claim 1 wherein the first programming language is HyperText Markup Language (HTML).

3. The software development platform according to claim 1 wherein the second programming language is JavaScript (JS).

4. The software development platform according to claim 1 wherein the third programming language is Java.

5. The software development platform according to claim 1 wherein the text-based data format is JavaScript Object Notation (JSON).

6. The software development platform according to claim 1 wherein the customised software model includes one or more view modules.

7. The software development platform according to claim 6 wherein the one or more view modules includes one or more CRUD input tags.

8. The software development platform according to claim 7 wherein the one or more CRUD input tags includes one or more of: a text tag; an email tag; a password tag; a number tag; a uniform resource locator (URL) tag; a contact tag; one or more date tags; a text area tag; a toggle button tag; an address tag; a dropdown menu tag (single or multi selection); a checkbox tag; a radios tag; and a hidden input tag.

9. A method for creating a customised software product in the form of a persistent storage application associated with a relational database, using the software development platform of claim 1, the method including the steps of:
setting up, via the input module, a server environment upon which the software development platform is deployed;
creating, via the input module, an empty product from the software development platform;
inputting client data in at least a first programming language into the input module, the client data including code for rendering one or more features to be included in the customised software product;
based on the inputted client data, automatically utilising one or more of the pre-programmed code blocks of the second type and one or more of the pre-programmed code blocks of the third type to generate the customised software product; and
outputting, via the output module, the customised software product.

10. The method according to claim 9 wherein the first programming language is HyperText Markup Language (HTML).

11. The method according to claim 9 wherein the second programming language is JavaScript (JS).

12. The method according to claim 9 wherein the third programming language is Java.

13. A software development platform for creating a customised software product including a displayed widget, the platform including:
an input module for facilitating input of client data;
a framework module including:
a first programming language module for receiving at least part of the inputted client data in a first programming language;
a second controller module including data in a second programming language, the second module including a plurality of pre-programmed code blocks of a second type; and
a third centralised data controller module including data in a third programming language, the third module for receiving at least part of the inputted client data in a third programming language, wherein the first, second and third modules are operatively associated with each other such that, based on the inputted client data, the framework module automatically calls data in a third programming language to utilise one or more of the pre-programmed code blocks of the second type to generate the customised software product; and
an output module for outputting the customised software product including the displayed widget,
wherein the third centralised data controller module utilizes a plurality of data rendering objects to map a third programming language entity to a relational database and subsequently maps to the third programming language entity a third programming language data rendering object, and the second controller module calls from the third module the third programming language data rendering object to be rendered in a text-based data format for formatting at least part of the outputted customised software product,
further wherein the third centralised data controller module is configured to read one or more annotation instructions to automatically carry out one or more “create, read update, and delete” (CRUD) operations,
further wherein the platform provides within the third module at least the following distinct framework annotations to define an entity:
an entity annotation including one or more of: a rendering entity attribute; an entity document attachment path prefix attribute; an entity file type attribute; an entity validation method attribute; an entity display name attribute; and an entity description attribute;
a CRUD list behavior annotation including one or more of: a list column order attribute; a list ascending or descending order attribute; and a list columns attribute; and
a CRUD list column annotation including one or more of: a parameter name attribute; a column heading attribute; and a filter field attribute, and
wherein the third centralised data controller module is separate from a page dispatcher.

14. The software development platform according to claim 13 wherein the first programming language is HyperText Markup Language (HTML).

15. The software development platform according to claim 13 wherein the second programming language is JavaScript (JS).

16. The software development platform according to claim 13 wherein the third programming language is Java.

17. The software development platform according to claim 13 wherein the customised software model includes one or more view modules.

18. The software development platform according to claim 17 wherein the one or more view modules includes one or more widget templates.

19. The software development platform according to claim 18 wherein the one or more widget templates includes one or more of: a chart widget; a document widget; one or more multimedia widgets; a map widget; a table widget; and a vector map widget.

20. The software development platform according to claim 19, wherein the one or more multimedia widgets includes one or more images widgets and/or one or more video widgets.

21. A method for creating a customised software product including a displayed widget, using the software development platform of claim 13, the method including the steps of:
setting up, via the input module, a server environment upon which the software development platform is deployed;
creating, via the input module, an empty product from the software development platform;
inputting client data in a first programming language into the input module, the client data including code for rendering one or more features to be included in the customised software product;
based on the inputted client data, automatically calling data in a third programming language to utilise one or more of the pre-programmed code blocks of the second type to generate the customised software product; and
outputting, via the output module, the customised software product.

22. The method according to claim 21 wherein the first programming language is HyperText Markup Language (HTML).

23. The method according to claim 21 wherein the second programming language is JavaScript (JS).

24. The method according to claim 21 wherein the third programming language is Java.
